(19) United States
(12) Patent Application Publication
(10) Pub. No.: US 2024/0386718 A1
(43) Pub. Date: Nov. 21, 2024

(54) PORTABLE INFORMATION TERMINAL AND INFORMATION PROCESSING METHOD

(71) Applicant: Maxell, Ltd., Kyoto (JP)

(72) Inventors: Yasunobu HASHIMOTO, Kyoto (JP); Tamotsu ITO, Kyoto (JP); Osamu KAWAMAE, Kyoto (JP); Hitoshi AKIYAMA, Kyoto (JP); Nobuo MASUOKA, Kyoto (JP)

(21) Appl. No.: 18/721,604

(22) PCT Filed: Dec. 22, 2021
(86) PCT No.: PCT/JP2021/047712

§ 371 Date: Jun. 18, 2024

(51) Int. Cl. G06V 20/20; G06V 40/20

(52) U.S. Cl. CPC G06V 20/20; G06V 40/20

(57) ABSTRACT

In a conventional apparatus for displaying interviewee information on a portable information terminal held by a user, when the user actually faces an interviewee, it is not possible to quickly acquire information relating to the interviewee at timing immediately before an interview, and such information have been acquired after start of the interview. For this reason, there have been awkward situations where the user and the interviewee cannot be on the same topic at the start of the interview. A portable information terminal according to a representative embodiment of the present invention determines whether or not a person in the vicinity of a user is a potential interviewee by performing behavior analysis on such a person, and when it is determined that the person is a potential interviewee, acquires information relating to the person to present it to the user. Consequently, the user is allowed to previously be aware of the information relating to the interviewee before the start of the interview or at timing at which the person is recognized as an interviewee.

### TECHNICAL FIELD

The present invention relates to a portable information terminal and an information processing method.

### BACKGROUND ART

Regarding a person who faces directly and conversates once in times past (referred to as “a face-to-face person” below), a case where meeting the person next is years later or a case where a person who faces several times in the past but has not frequently seen visits you unexpectedly one day may not occur a little.

Then, there may be caused uncomfortable situations in which when you face-to-face see such a person you met in the past, you completely forget the information (such as name) on the face-to-face person and you cannot say (recall) the name of the face-to-face person though the face-to-face person can say your name at the start of conversation.

In order to avoid the situations whenever possible, information on many friends and persons involved may be described and recorded in a datebook or the like (whether paper-based medium or electronic medium) of a user. To the contrary, similar problems to the above may happen even to the user who described and recorded such information if he/she met a remarkably large number of persons in the past (or have a remarkably large amount of information on persons recorded in a datebook or the like).

More specifically, as the information on the persons recorded in a datebook or the like (the persons you met in the past) increases, the recorded information on the persons gradually (from the oldest information, for example) disappears from the memories (conscious mind) in the brain of the user. Thus, if a person the user met in the past unexpectedly visits him/her one day, the user cannot extract keywords for the face-to-face person from the brain in a short time, which may cause an uncomfortable situation in which the user cannot say (recall) the name of the face-to-face person at the start of conversation.

In recent years, a user carries a portable information terminal including electronic information with face photographs, previously checks information on the face-to-face person (interviewee) before seeing him/her, and recalls him/her from memory of the user in preparation for an interview with him/her. Such a portable information terminal storing electronic information therein can be an effective tool when the face-to-face person (interviewee) is previously known. However, in the above cases, or when a person whose electronic information such as face photograph is stored in the portable information terminal unexpectedly visits and sees the user one day, similar problems to the above can occur.

In other aspects, a user, who uses the above tool, needs to frequently check the information recorded in the tool and to always refresh the memory in order to be able to immediately say the information such as name to a person who unexpectedly visits the user. However, such works can be complicated and prolonged in their time as the recorded information increases. Additionally, many users think it inefficient or have a sense of resistance (reluctance) against refreshing the memory of the information on a remarkably large number of persons for the near future although only a few persons unexpectedly visit the users.

Generally, such a portable information terminal may not be an effective tool since users cannot cope with an unexpected visitor.

In the meantime, in recent years, face recognition techniques have progressed and portable information terminals mounting a small-sized camera thereon have been widely used, and with the use of the techniques, a person (interviewee) can be identified and information on the interviewee can be acquired.

For example, Patent Document 1 discloses a technique for a method with which a user faces an interviewee and acquires information on the interviewee.

### RELATED ART DOCUMENTS

### Patent Documents

Patent Document 1: Japanese Unexamined Patent Application Publication No. 2018-106579

### SUMMARY OF THE INVENTION

### Problems to be Solved by the Invention

The method disclosed in Patent Document 1 is performed in the following procedure.
(1) A user shoots an interviewee by a camera equipped in a head mounted display (HMD) as a portable information terminal.
(2) A face image authentication processing is performed on the shot image thereby to identify a face image and specify the interviewee.
(3) Information on the specified interviewee is acquired.
(4) The acquired information on the interviewee is notified to the user.

However, with the technique disclosed in Patent Document 1, the user needs to face the interviewee, and acquires the information on the interviewee after the facing, and thus a time lag until the information acquisition is caused. In other words, with the technique disclosed in Patent Document 1, the user needs to determine that “the person is (may be) my interviewee.” Consequently, the user starts an interview with no or less information on the interviewee, and inconvenience such as a gap in conversation at the start of the interview is caused. Particularly when the interviewee earlier recognizes the information (such as name, profession, and the like) on the user than the user, time is wasted until the user recognizes that “the person is (may be) my interviewee” in addition to the time lag.

The present invention is directed to provide a portable information terminal and an information processing method capable of more rapidly providing a user with information on an interviewee.

### Means for Solving the Problems

Outlines of representative inventions among the inventions disclosed in the present application will be briefly described below.

A portable information terminal according to representative aspects of the present invention determines whether a person around a user can be an interviewee by analyzing a behavior of the person, and when determining that the person can be an interviewee, previously acquires collateral information on the person. Consequently, when the user recognizes the person as an interviewee, the user knows the collateral information on the interviewee.

### Effects of the Invention

Effects achieved by representative inventions among the inventions disclosed in the present application will be briefly described below.

That is, according to representative aspects of the present invention, a determination as to whether a person around the user can be an interviewee is automatically made by the portable information terminal, and when it is determined that the person can be an interviewee, collateral information on the person is acquired. Therefore, the information on the interviewee can be more rapidly provided to the user.

### BRIEF DESCRIPTION OF THE DRAWINGS

FIG. 1 is a schematic diagram for explaining an outline of the present invention;

FIG. 2 is an appearance view depicting an exemplary HMD according to a first embodiment;

FIG. 3 is a system configuration diagram depicting an exemplary internal configuration of the HMD according to the first embodiment;

FIG. 4 is a functional block diagram depicting an exemplary functional block configuration of the first embodiment;

FIG. 5 is a flowchart of a new interviewee processing according to the first embodiment;

FIG. 6 is a flowchart depicting a subroutine of a face information detection processing according to the first embodiment;

FIG. 7 is an exemplary table in which interviewee information is saved according to the first embodiment;

FIG. 8 is a flowchart of an interviewee identification and information acquisition processing according to the first embodiment;

FIG. 9 is a flowchart depicting a subroutine of an interviewee information processing according to the first embodiment;

FIG. 10 is a system configuration diagram depicting an exemplary internal configuration of the HMD 1 according to a second embodiment;

FIG. 11 is a functional block diagram depicting an exemplary functional block configuration of the second embodiment;

FIG. 12 is a flowchart of a new interviewee processing according to the second embodiment;

FIG. 13 is a flowchart depicting a subroutine of a voice information detection processing according to the second embodiment;

FIG. 14 is an exemplary table in which interviewee information is saved according to the second embodiment;

FIG. 15 is a flowchart of an interviewee identification and information acquisition processing according to the second embodiment;

FIG. 16 is a flowchart of an interviewee information processing according to the second embodiment;

FIG. 17 is a schematic diagram for explaining an outline of a third embodiment;

FIG. 18 is a flowchart of an interviewee identification and information acquisition processing according to the third embodiment;

FIG. 19 is a flowchart of a voice information-alone processing according to the third embodiment;

FIG. 20 is an appearance view depicting an exemplary HMD used in a fourth embodiment;

FIG. 21 is a flowchart of an interviewee identification and information acquisition processing according to a fifth embodiment;

FIG. 22A is exemplary information display according to the first embodiment;

FIG. 22B is exemplary information display according to the first embodiment; and

FIG. 23 is exemplary information display according to the fifth embodiment.

### DETAILED DESCRIPTION OF PREFERRED EMBODIMENTS

Specific examples of embodiments to which the present invention is applied will be described below in detail with reference to the drawings. The embodiments described below are exemplary for achieving the present invention and do not intend to limit the technical scope of the present invention. Incidentally, members with the same function are denoted with the same reference numeral and repeated description thereof will be omitted unless otherwise needed in the embodiments.

### First Embodiment

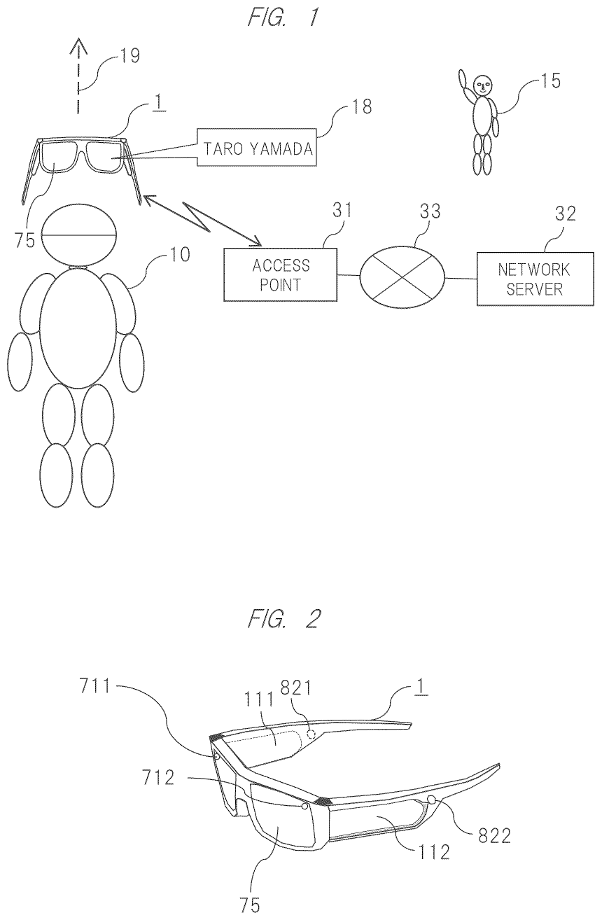

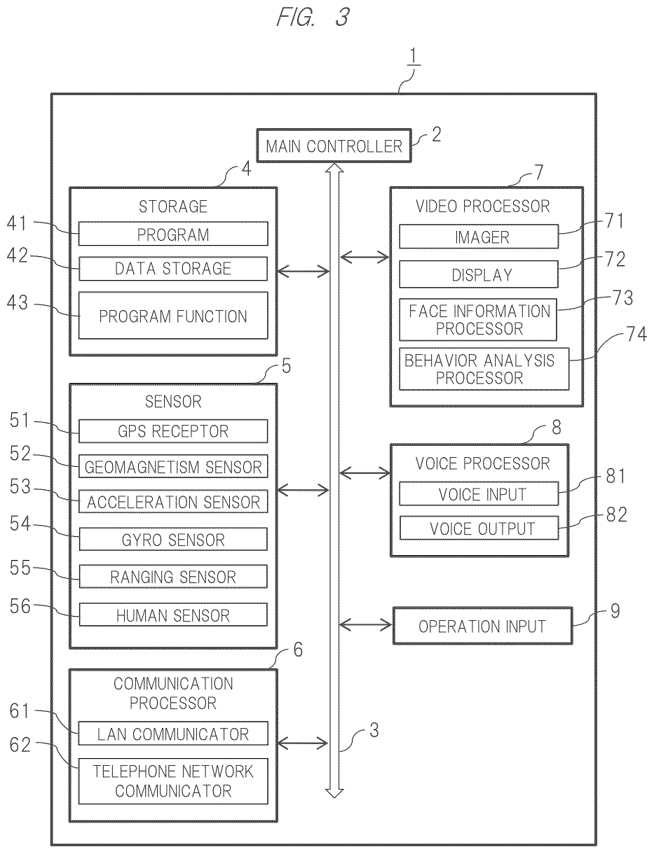

A first embodiment according to the present invention will be first described with reference to FIGS. 1 to 3. Here, FIG. 1 is a schematic diagram for explaining an outline of the first embodiment. Further, FIG. 2 is an appearance view depicting an exemplary HMD according to the first embodiment. Furthermore, FIG. 3 is a system configuration diagram depicting an exemplary internal configuration of the HMD according to the first embodiment.

FIG. 1 schematically depicts a scene in which a person 15 is present in front of a user 10 wearing a glasses-type transmissive HMD 1. Incidentally, the transmissive HMD 1 is depicted away from the user 10 in FIG. 1 for convenience of the description, but the user 10 is assumed to look ahead while wearing the HMD1 on the face (where he/she is to wear glasses). Further, the person 15 may be referred to as “interviewee 15” below.

The transmissive HMD 1 according to the present embodiment includes a translucent (transmissive) display screen 75 (display) at the positions of the lenses of glasses. The user can view the real space through the transmissive display screen 75. Further, an augmented reality (AR) object (interviewee information) can be displayed on the display screen 75. Thus, a person who wears the HMD 1 (the user 10 in this example) can view both the augmented reality (AR) object (interviewee information) displayed on the display screen 75 and the situation in the real space at the same time.

FIG. 1 depicts that the interviewee 15 is not present in a line of sight 19 of the user 10 and the user 10 does not recognize the presence of the interviewee 15. More specifically, since the user 10 wears the HMD 1, his/her field of view in the real space except in the line of sight 19 is slightly narrower than he/she looks at it with the naked eyes. To the contrary, the interviewee 15 earlier recognizes the presence of the user 10 and raise the right hand than the user 10 recognizes the presence of the interviewee 15.

In the present embodiment, for example, in the scene depicted in FIG. 1, the HMD 1 is activated and then rapidly acquires surrounding information of the HMD 1 by use of a surrounding information acquiring apparatus. As a specific example, “surrounding information” is any of a video, distance information, and voice, or a combination thereof.

With reference to the blocks of FIG. 3, an imager 71 configured to acquire a video around the HMD 1 (and the user 10 carrying the HMD 1), a sensor 5 including a ranging sensor 55 configure to acquire distance data (distance between the user and an object), a human sensor 56 configured to sense the presence or approach of a person, and the like, and a voice input 81 such as a microphone configured to collect (acquire) voice around the user serve as the surrounding information acquiring apparatus. The HMD 1 analyzes surrounding information acquired by the surrounding information acquiring apparatus thereby to recognize the person 15 who is present around the user (or who appears in front of him/her).

Incidentally, FIG. 1 according to the first embodiment depicts an example in which only the imager 71 is used as a surrounding information acquiring apparatus and a video around the user is acquired as surrounding information by the imager 71. To the contrary, in a second embodiment described below, the imager 71 and the voice input 81 are used as surrounding information acquiring apparatuses. Further, in a third embodiment described below, only the voice input 81 is used as a surrounding information acquiring apparatus.

The HMD 1 determines, by a behavior analysis processor 74, whether the person 15 can be an interviewee, and when determining that he/she can be an interviewee, acquires collateral information on the person 15. The acquired collateral information is presented to the user by an information presentation.

The collateral information is presented by either or both of an image and voice. When the information is presented by an image, the display screen 75 controlled by a display 72 serves as the information presentation. To the contrary, when the information is presented by voice, a voice output 82 serves as the information presentation.

FIG. 1 depicts an example in which the collateral information on the person 15 is displayed on the display screen 75. That is, a name 18 (“Taro Yamada” in this example) is displayed as the collateral information on the person 15 on the display screen 75 in FIG. 1.

Incidentally, in the present specification, the terms “video” and “image” are assumed to include both a moving image and a still image.

As depicted in FIG. 1, the HMD 1 is configured to be connectable with a network server 32 on a network 33. More specifically, the HMD 1 is connected to an access point 31 by a communication processor 6 described below in FIG. 2 and makes communication with the network server 32 connected to the network 33 via the access point 31. The network server 32 depicted in FIG. 1 includes various servers such as a processing server for performing various computation processings and a data server for storing various items of data. Thus, the HMD 1 makes communication with the servers as needed thereby to use various external resources.

FIG. 2 is an appearance view depicting an example of the HMD 1 used in the present embodiment. The display screen 75 is configured at the positions of the right and left lenses of glasses where a right camera 711 is arranged on the edge of the right lens of the glasses and a left camera 712 is arranged on the edge of the left lens of the glasses.

Further, though not depicted, microphones are arranged near the right camera 711 and the left camera 712, respectively. Furthermore, a right speaker 821 and a left speaker 822 are arranged on the positions corresponding to the temples of glasses.

Further, the electronic components such as circuits of the HMD 1 are divided and stored in a right casing 111 and a left casing 112.

A specific method for solving the problem of the present disclosure or for enabling information on an interviewee to be rapidly presented to a user will be described below in more detail with reference to the drawings.

### [Exemplary System Configuration of HMD]

The main body of the HMD 1 utilized in the present invention is configured of various blocks described below.

FIG. 3 is a system configuration diagram depicting an exemplary internal configuration of the HMD 1. As depicted in FIG. 3, the HMD 1 is configured of a main controller 2, a system bus 3, a storage 4, the sensor 5, the communication processor 6, a video processor 7, a voice processor 8, an operation input 9, and the like.

The main controller 2 is a microprocessor unit configured to totally control the HMD 1 according to a predetermined operation program. The system bus 3 is a data communication path for exchanging various commands and data between the main controller 2 and the respective constituent blocks in the HMD 1.

The storage 4 is configured of a program 41 configured to store programs and the like for controlling the operations of the HMD 1, a data storage 42 configured to store various items of data such as objects including operation setting values, detection values from sensors, and contents, and library information downloaded from libraries, and a rewritable program function 43 such as a work area used in various program operations.

Further, the storage 4 can store operation programs downloaded from the network, various items of data created according to the operation programs, and the like. Further, the storage 4 can store contents such as moving images, still images, and voice downloaded from the network. Further, the storage 4 can store data such as moving images or still images shot by use of an imaging function of a camera. Further, the storage 4 can previously store necessary information (including setting values such as thresholds, image data, and the like).

Further, the storage 4 needs to hold its storing information even when the HMD 1 is not supplied with power from the outside. Thus, the storage 4 employs devices including semiconductor device memories such as flash ROM or solid state drive (SSD), magnetic disc drive such as hard disc drive (HDD), and the like, for example. Incidentally, each operation program stored in the storage 4 can be updated or enhanced by a download processing from each server apparatus on the network.

The sensor 5 is a group of sensors (or “sensor apparatuses”) including various sensors configured to detect a state of the HMD 1. The sensor 5 is configured of a global positioning system (GPS) receptor 51, a geomagnetism sensor 52, an acceleration sensor 53, a gyro sensor 54, a ranging sensor 55, a human sensor 56, and the like.

The sensor 5 can detect a position, a tilt, an angle, a motion, and the like of the HMD 1 through the sensors. Further, the sensor 5 can measure a distance to an object (interviewee or others). Thus, the sensor 5 configures part of the surrounding information acquiring apparatus configured to acquire surrounding information including information on an interviewee.

The ranging sensor 55 among the above sensors is in the form of optical time of flight (ToF), for example, and measures a distance to an object (person and his/her belongings (such as glasses, hat, cane, flag, clothes, mask, and the like), a building, a road, and the like) in the surroundings of the HMD 1 and the user 10 (which may be simply referred to as “in the surroundings” for brevity).

Incidentally, “in the surroundings of the HMD 1 and the user 10” may be referred to as “in the surroundings” below for brevity.

Further, the human sensor 56 is of an infrared type, for example, and can selectively sense a person among the surrounding objects described above.

Additionally, the global positioning system (GPS) receptor 51 acquires actual position information by use of satellite communication thereby to acquire the position of the HMD 1 or the position where surrounding information is to be acquired. Further, other system such as a system in global navigation satellite system (GNSS) may be used for acquiring actual position information.

Incidentally, the sensor 5 may further include other sensors, for example, detection or measurement apparatuses such as an illumination sensor and an altitude sensor, and the sensors may be components of the surrounding information acquiring apparatus.

The communication processor 6 is a communication apparatus including a local area network (LAN) communicator 61, a telephone network communicator 62, and the like. The LAN communicator 61 is connected to the network 33 (see FIG. 1 as needed) such as Internet via the access point 31 or the like thereby to exchange data each network server 32 on the network 33. Connection between the LAN communicator 61 and the access point 31 or the like is made by wireless communication such as Wi-Fi (trademark).

Incidentally, the main controller 2 can cause an external server (the network server 32) to perform at least some of the characteristic processings performed by the HMD 1 via the communication processor 6 (the communication apparatus).

The telephone network communicator 62 makes telephone communication (calls) and exchanges data by wireless communication with base stations and the like of mobile telephone communication networks. Communication with base stations and the like may be made in the long term evolution (LTE) system, the 5G system (fifth generation mobile communication system for enhanced mobile broadband, low latency, and massive machine type communication), or other communication system.

Each of the LAN communicator 61 and the telephone network communicator 62 includes encoding circuitry, decoding circuitry, an antenna, and the like. Further, the communication processor 6 may additionally include other communicator such as an infrared communicator.

The video processor 7 includes the imager 71, the display 72, a face information processor 73, and the behavior analysis processor 74.

The imager 71 is a camera configured to input image data (video) of the surroundings or an object by converting a light input from a lens by use of an electronic apparatus such as a charge coupled device (CCD) or a complementary metal oxide semiconductor (CMOS) sensor into an electric signal. In the present embodiment, the imager 71 includes the right camera 711, the left camera 712, and the like.

The imager 71 (the right camera 711 and the left camera 712) configures part (imaging apparatus or image acquiring apparatus) of the surrounding information acquiring apparatus configured to acquire surrounding information including information on an interviewee.

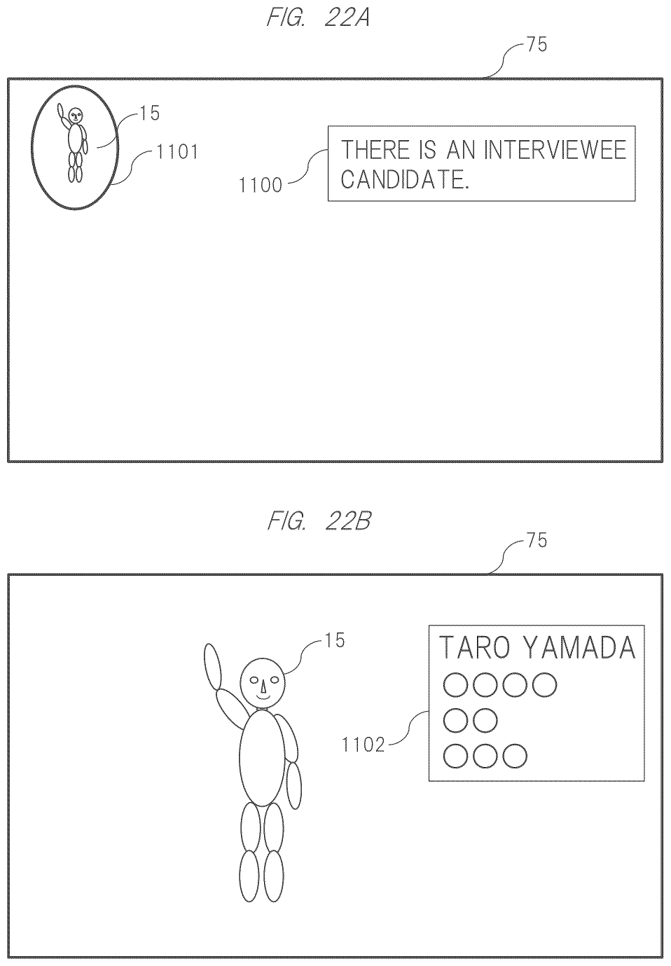

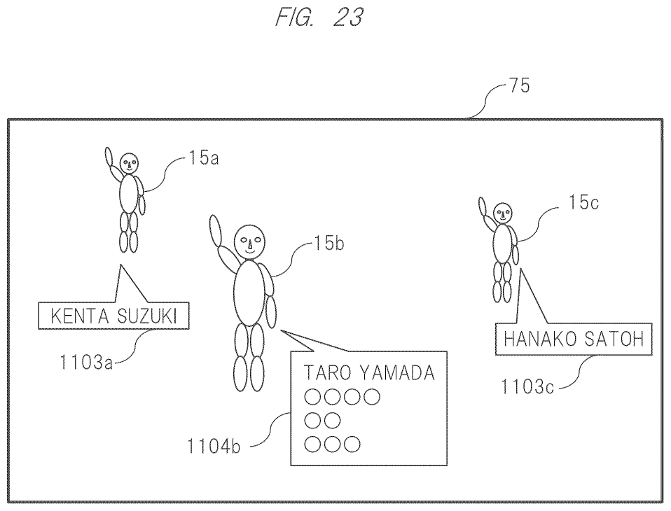

The display 72 is a display (liquid crystal display apparatus) with a transmissive display of translucent liquid crystal, for example. The display 72 configures the display screen 75 (see FIGS. 22A, 22B, and 23 as needed) and provides the user 10 of the HMD 1 with collateral information on an interviewee, and the like.

The face information processor 73 is configured to extract face information from a video of an interviewee shot by the imager 71. The processings performed by the face information processor 73 will be described below in detail.

The behavior analysis processor 74 is configured to analyze a behavior of a person on the basis of a video of the person shot by the imager 71 or a distance to the person measured by the ranging sensor 55. The processings performed by the behavior analysis processor 74 will be described below in detail.

As a specific example, the face information processor 73 and the behavior analysis processor 74 are separately configured of different processors. As other example, the processor 73 and 74 may be configured of the same processor.

The voice processor 8 is configured of the voice input 81 and the voice output 82.

The voice input 81 is a microphone configured to convert sound in the real space or user's voice into voice data for input. In the present embodiment, microphones are arranged near the right camera 711 and the left camera 712, respectively.

The voice input 81 configures part (sound collecting apparatus or voice acquiring apparatus) of the surrounding information acquiring apparatus configured to acquire surrounding information including information on an interviewee.

The voice output 82 is a speaker configured to output voice information and the like needed by the user. In the present embodiment, the voice output 82 includes the right speaker 821 and the left speaker 822 arranged near user's ears, respectively. Though not depicted, the voice output 82 may include wired or wireless terminals for connecting with external voice output equipment such as earphones and headphones. With the thus-configured HMD 1, methods for outputting voice or routes of voice can be appropriately used depending on their purpose or the like.

The operation input 9 is a hardware apparatus including key switches for inputting an operation instruction and the like for the HMD 1, and outputs an operation input signal according to user's operation contents (input instruction) to the main controller 2.

In the present disclosure, the operation input 9 and the main controller 2 function as setting or setting processing apparatuses configured to set characteristic functions (such as surrounding information acquisition, behavior analysis processing, and information presentation, for example) in the HMD 1. Other components of the setting or setting processing apparatuses may include the display 72.

Incidentally, the exemplary hardware configuration of the HMD 1 depicted in FIG. 3 includes components and the like less relevant to the configuration for solving the above problem. Thus, a configuration, which does not include components and the like less relevant to solving the problem, will not impair effects specific to the present embodiment. Moreover, components not depicted, such as electronic money settlement function, may be further added.

### [Functional Blocks of Present Embodiment]

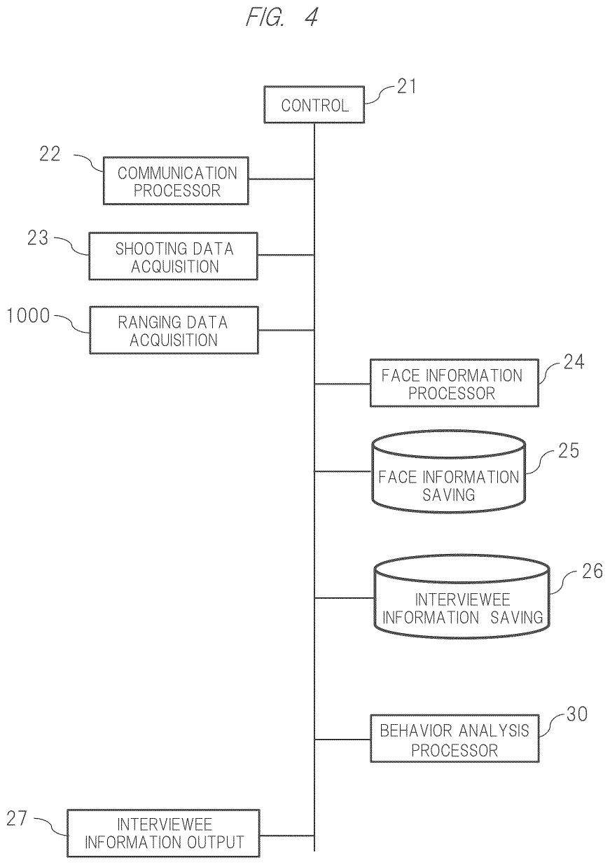

FIG. 4 is a functional block diagram depicting an exemplary functional block configuration of the HMD 1 according to the present embodiment. A control function 21 is to totally control the HMD 1, and is mainly configured of the program 41 and the program function 43 in the storage 4 as well as the main controller 2 as depicted in FIG. 4.

A communication processor function 22 in the functional block configuration is to perform a communication processing of connecting to the network 33 by the LAN communicator 61 in the communication processor 6 or the telephone network communicator 62 in the communication processor 6 (see also FIGS. 1 and 3 as needed).

A shooting data acquisition function 23 is to shoot an interviewee by the imager 71 (the right camera 711 and the left camera 712) in the video processor 7 and to acquire shooting data.

A face information processor function 24 is to analyze face information by the face information processor 73 from the video of the interviewee acquired by the shooting data acquisition function 23 and to determine the interviewee. The face information processing will be described below in detail.

A face information saving function 25 is to save the face information for determining the interviewee acquired by the face information processor function 24 in the data storage 42 in the storage 4.

An interviewee information saving function 26 is to save collateral information on the interviewee in the data storage 42 in the storage 4.

An interviewee information output function 27 is to read and display the collateral information on the interviewee saved in the interviewee information saving function 26 on the display 72 in the video processor 7.

A behavior analysis processor function 30 is to analyze a behavior of the person by the behavior analysis processor 74 from the video of the person acquired in the shooting data acquisition function 23 and a distance to the person acquired by a distance data acquisition function 1000 and to determine whether the person can be an interview candidate. An interview candidate determination processing will be described below in detail.

### [Processing Procedure of Present Embodiment]

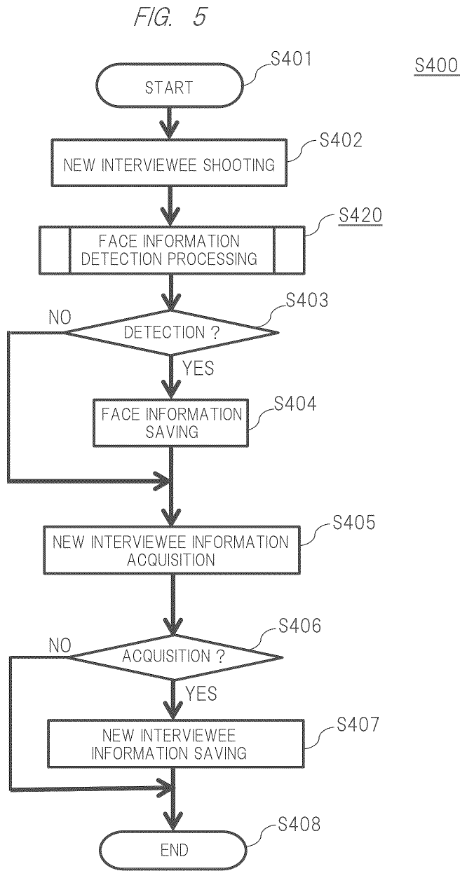

FIG. 5 is a flowchart depicting a procedure of a new interviewee processing (step S400) of acquiring information on a new interviewee according to the present embodiment. The processing procedure of FIG. 5 will be described below with reference to the functional block diagram of FIG. 4.

Incidentally, it is assumed that a permission of a new interviewee is gained in advance in terms of personal information protection in performing the new interviewee processing (step S400).

The new interviewee processing (step S400) of FIG. 5 is performed in the following procedure, for example. That is, after a startup processing (step S401) such as activating software or resetting a memory, at first a new interviewee is shot (step S402). This corresponds to a preprocessing in order to acquire face information from a video of the new interviewee.

Specifically, in step S402, when the imager 71 in the video processor 7 is operated under control of the main controller 2, a background or an object in front of the user of the HMD 1 is shot. Description will be made below assuming that the new interviewee is present in objects in front of the user.

A face information detection processing (step S420) as a defined processing (subroutine) is then performed. The face information detection processing (step S420) is to acquire face information on the new interviewee. Specifically, in step S420, the face information processor 73 in the video processor 7 analyzes an image of the object shot in step S402 under control of the main controller 2 thereby to acquire face information on the new interviewee. With the processing, the face information for identifying the new interviewee is acquired.

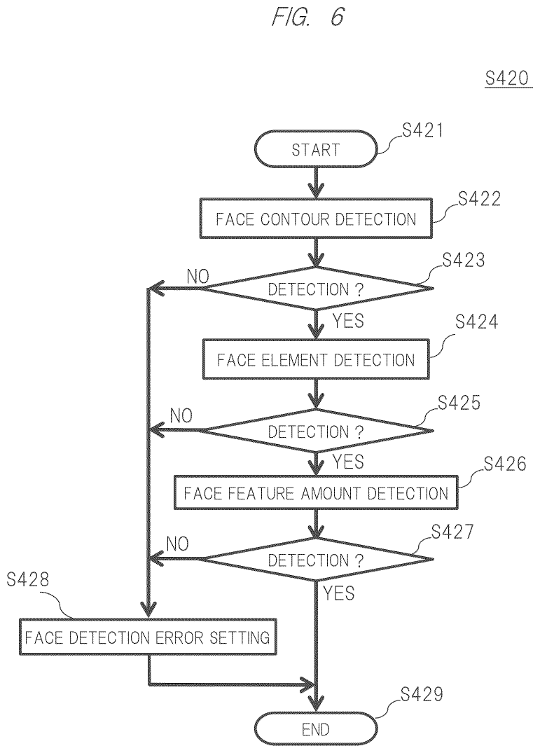

The processing procedure of step S420 (the face information detection processing) will be described herein in more detail with reference to FIG. 6. FIG. 6 is a flowchart depicting the processing procedure of the subroutine of the face information detection processing (step S420).

The processing procedure of FIG. 6 will be described below with reference to the block diagram of FIG. 3 and the functional block diagram of FIG. 4. The face information processor 73 reads and sequentially executes programs of a face recognizing method stored in the program 41 in the storage 4 in order to perform the face information processor function 24.

Specifically, after the startup processing (step S421) such as activating software or resetting a memory, at first the face information processor 73 performs a processing of detecting a face contour of the new interviewee in the shooting frame by a face contour detection program (step S422).

In next step S423, the face information processor 73 determines whether the face contour of the new interviewee has been detected in the face contour detection processing (step S422).

Here, when determining that the face contour of the new interviewee has not been detected (step S423: NO), the face information processor 73 proceeds to a face detection error setting processing (step S428) of setting a face detection error.

To the contrary, when determining that the face contour of the new interviewee has been detected (step S423: YES), the face information processor 73 proceeds to a face element detection processing (step S424).

In the face element detection processing (step S424), the face information processor 73 performs a processing of detecting an element such as eyes, nose, mouth or the like inside the face contour by a face element detection program.

In next step S425, the face information processor 73 determines whether a face element of the new interviewee has been detected in the face contour detection processing (step S424).

Here, when determining that a face element of the new interviewee has not been detected (step S425: NO) in the face contour detection processing (step S424), the face information processor 73 proceeds to the face detection error setting processing (step S428) of setting a face detection error.

To the contrary, when determining that a face element of the new interviewee has been detected in the face contour detection processing (step S424), the face information processor 73 proceeds to a next face feature detection processing (step S426).

In the face information feature detection processing (step S426), the face information processor 73 performs a processing of detecting a face feature such as size of each element, position thereof, positional relationship between elements, or the like by a face feature detection program.

In next step S427, the face information processor 73 determines whether a face feature of the new interviewee has been detected in the face information feature detection processing (step S426).

Here, when determining that a face feature of the new interviewee has not been detected (step S427: NO) in the face information feature detection processing (step S426), the face information processor 73 proceeds to the face detection error setting processing (step S428) of setting a face detection error.

To the contrary, when determining that a face element of the new interviewee has been detected (step S427: YES) in the face information feature detection processing (step S426), the face information processor 73 terminates the face information detection processing (step S420) (step S429).

Further, the face information processor 73 clearly indicates when the face detection error occurred in the face detection error setting processing (step S428), and terminates the face information detection processing (step S420) (step S429).

As other example, the face information detection processing (step S420) may be performed by the network server 32. In this case, the main controller 2 in the HMD 1 controls the communication processor 6 thereby to send a video of the new interviewee shot by the video processor 7 (the imager 71) via the network 33 to the network server 32 which performs the face information detection processing. Subsequently, the main controller 2 in the HMD 1 receives (only) a result of the face information detection performed by the network server 32 from the network server 32 via the network 33.

Return to the description of the processing procedure in the flowchart of FIG. 5 here. In step S403 subsequent to the face information detection processing (step S420), the face information processor 73 determines whether face information on the new interviewee has been acquired in the face information detection processing (step S420).

Here, when determining that face information on the new interviewee has not been acquired (step S403: NO) in the face information detection processing (step S420), the face information processor 73 determines that there is no face information to be saved, and proceeds to a new interviewee information processing (step S405).

To the contrary, when determining that face information on the new interviewee has been acquired (step S403: YES) in the face information detection processing (step S420), the face information processor 73 proceeds to a face information saving processing (step S404).

In the face information saving processing (step S404), the face information processor 73 performs the face information saving function 25 (see FIG. 4) thereby to save face features of the interviewee for interviewee's face identification in the data storage 42 in the storage 4. The face information processor 73 then proceeds to the new interviewee information acquisition processing (step S405).

The new interviewee information acquisition processing (step S405) is a processing of acquiring collateral information on the new interviewee. In step S405, the face information processor 73 performs the processing of acquiring collateral information on the new interviewee such as his/her name, age, and the like.

Next, the face information processor 73 determines whether the collateral information on the new interviewee has been acquired (step S406) in the new interviewee information acquisition processing (step S405).

Here, when determining that the collateral information on the new interviewee has not been acquired (step S406: NO), the face information processor 73 terminates the new interviewee processing (step S400) of FIG. 5 (step S408).

To the contrary, when determining that the collateral information on the new interviewee has been acquired (step S406: YES), the face information processor 73 proceeds to step S407. In step S407, the face information processor 73 performs the interviewee information saving function 26 (see FIG. 4) thereby to save the acquired collateral information on the new interviewee in the data storage 42 in the storage 4, and then terminates the new interviewee processing (step S400) of FIG. 5 (step S408).

Incidentally, when the collateral information on the new interviewee is saved in the network server 32, the HMD 1 can acquire the collateral information on the new interviewee from the network server 32 via the network 33 under control of the main controller 2. Also in this case, the face information processor 73 saves the collateral information on the new interviewee acquired from the network server 32 in the data storage 42 in the storage 4, and then terminates the new interviewee processing (step S400) (step S408).

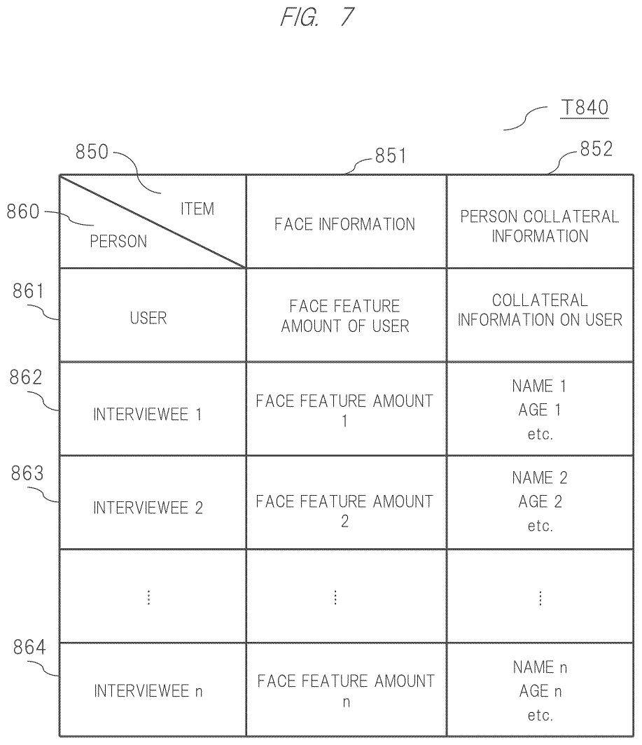

FIG. 7 is a table depicting exemplary interviewee information saved in the data storage 42 in the storage 4.

An interviewee table (T840) of FIG. 7 is configured such that person columns 860 indicating types of persons (such as interviewees) are associated with item columns 850 indicating information (items) on a user and interviewees (interviewee 1, interviewee 2, . . . interviewee n).

The item columns 850 in the interviewee table are configured of two items including face information 851 and collateral information on interviewee 852.

To the contrary, a user 861 is registered in the person columns 860 in addition to interviewees (862 to 864). Incidentally, the user 861 is present in the person columns 860 originally indicating types of interviewees like a profile in a cell phone. Further, the face information 851 on the user (861) can be acquired by shooting himself/herself on a mirror (a mirror-reversed image is acquired in this case) or by taking a “selfie,” for example.

The interviewee table (T840) as depicted in FIG. 7 can be saved in the network server 32 via the network 33. Especially for face features, a processing of specifying an interviewee can be achieved at higher speed by use of the network server 32 dedicated to the processing of specifying an interviewee from a face feature.

In the present embodiment, face information on a new interviewee and collateral information on the new interviewee can be acquired and saved in the HMD 1 by use of the processings depicted in FIGS. 5 and 6 and the table in the data structure as depicted in FIG. 7.

### [Interviewee Identification and Information Acquisition Processing]

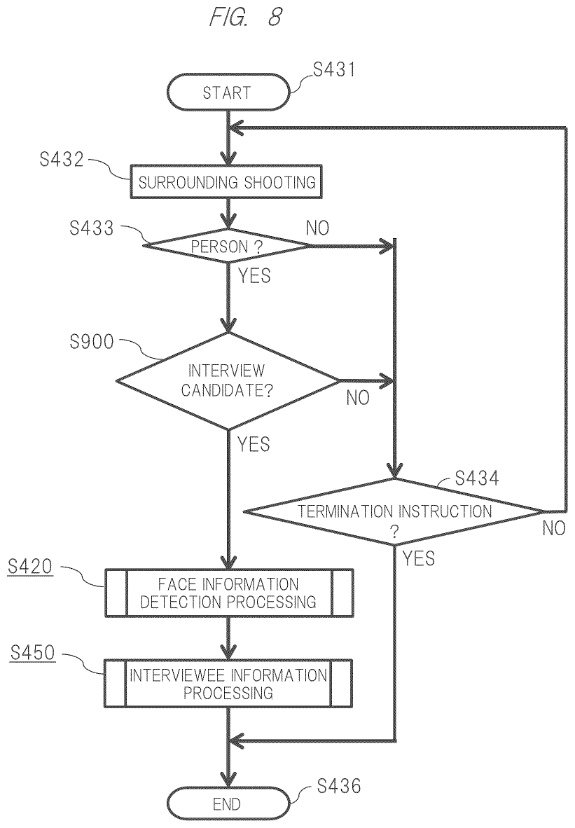

A processing of identifying an interviewee and acquiring collateral information on the interviewee will be described below. FIG. 8 is a flowchart depicting, as a framework of the present embodiment, a procedure of the processing (interviewee identification and information acquisition processing) of determining whether a person can be an interviewee, and when the person can be an interviewee, previously acquiring collateral information on the interviewee.

The processing procedure of FIG. 8 will be described with reference to the block diagram of FIG. 3 and the functional block diagram of FIG. 4. Incidentally, the following description will be made assuming that the main controller 2 controls the respective processings depicted in FIG. 8, but some or all of the processings may be performed by the behavior analysis processor 74.

When the HMD 1 is activated, the main controller 2 rapidly starts the processing (step S431) in order to perform the processings such as interviewee identification, information acquisition, and the like.

When starting the interviewee identification and information acquisition processing (step S431), at first the main controller 2 performs a surrounding shooting processing (step S432). This is a processing of shooting circumstances (landscape or scene) around the HMD 1 or around the user 10 by the shooting data acquisition function 23 and acquiring shooting data.

Here, the shooting data to be acquired may be a moving image or a still image. When the shooting data is a moving image, higher accuracy of behavior analysis can be expected than when being a still image. To the contrary, when the shooting data is a still image, lower power consumption of the HMD 1 can be expected than when being a moving image. Incidentally, when the shooting data is a still image, shooting is to be performed or a still image is to be acquired at predetermined time intervals in order to keep accuracy of behavior analysis above a certain level.

In order to perform the processing, the main controller 2 controls the video processor 7 such that the imager 71 starts shooting. At this time, the video processor 7 performs shooting by the imager 71 (cameras), analyzes the shot image by the face information processor 73 and the behavior analysis processor 74, and outputs an analysis result to the main controller 2.

In step S433 after receiving the analysis result from the video processor 7, the main controller 2 determines whether a person is present in the acquired image (referred to as “shooting data” below).

Here, when determining that a person is not present in the shooting data (step S433: NO), the main controller 2 proceeds to a termination instruction determination processing in step S434.

To the contrary, when determining that a person is present in the shooting data (step S433: YES), the main controller 2 proceeds to an interview candidate determination processing in step S900.

In step S900 (the interview candidate determination processing), the main controller 2 determines whether a person around the user can be an interviewee. In the determination, when a person is paying attention to the user on the basis of a behavior analysis result of the person in the shooting data by the behavior analysis processor 74, the person is determined as a possible interviewee. A moving image or a still image may be additionally shot for the determination.

Here, conditions for determining that a person is paying attention to the user may be the following behaviors (person's behaviors), for example:
(Condition 1) A line of sight of a person is toward the user.
(Condition 2) A person is greeting the user by raising a hand, for example.
(Condition 3) A person is approaching the user.
(Condition 4) A person is calling the mane of the user or is telling the name of the person (or a company or institute to which the person belongs).

Condition 4 is a behavior based on speech (voice) of a person, and is not necessarily easy to acquire (extract) from an image. More specifically, what a person said (speech sound) can be estimated by analyzing motions of his/her lips in a moving image, for example. To the contrary, many people wear a mask for preventing infection of various diseases (such as new coronavirus) in recent society, and motions of the lips of a person would be difficult to analyze.

Conditions 1 to 3 will be mainly examined in the first embodiment and condition 4 will be described in the second and third embodiments in consideration of the above circumstances.

Conditions 1 to 3 described above are behaviors based on actions of the body of a person, and can be generally defined as “behaviors indicating interest in the user.” Thus, when a behavior of a person included in the shooting data (surrounding information) is a behavior indicating interest in the user 10, the main controller 2 (the behavior analysis processing apparatus) determines that the person can be an interviewee (step S900: YES).

A person who can be an interviewee will be referred to as “interview candidate” below as needed for description.

Incidentally, Conditions 1 to 3 described above are merely some examples of “behaviors indicating interest in the user” and various conditions (action forms of persons) can be added in actual operations.

Further, as an exceptional processing (determination standard), if a distance between the user and a person is shorter than a preset certain distance on the basis of a detection result of the human sensor 56, for example, the main controller 2 may determine that the person is an interview candidate (step S900: YES) irrespective of Conditions described above. This is because if the user 10 wears a mask, for example, a person may become aware of the user 10 only after approaching the user 10.

Further, as another exceptional processing (determination standard), even if a person is paying attention to the user (even if all of Conditions 1 to 3 are met, for example), the main controller 2 may determine that the person is not an interview candidate, or NO in step S900.

For example, this assumes that a store clerk in a store, a person in charge in a service such as a receptionist at a reception desk of a company, a security guard, and the like are paying attention to the user merely by profession. More specifically, collateral information on such persons is not usually registered, and if the processing of acquiring collateral information on such a person is performed, collateral information on a truly necessary person can be restricted from being acquired.

Further, in order to preferentially acquire collateral information on a truly necessary person, the processings depicted in FIG. 8 may not be performed (the functions may be automatically stopped) in specific places where the user sees only those who he/she knows, such as his/her home. In this case, the main controller 2 may determine whether the place is a “specific place” on the basis of reception information of the GPS receptor 51 (see FIG. 3).

Further, in order to preferentially acquire collateral information on a truly necessary person, those who the user frequently sees, such as his/her family members, may be excluded from the persons to be processed in step S420 and step S450 (or “persons to be excluded” are set). Further, a person on which the processings in step S420 and step S450 has been performed once may not be subjected to the processings in step S420 and step S450 for a certain period of time (or “display stop period” is set).

The settings of various exceptional processings described above (or exclusion setting) may be performed by the user's operating the operation input 9, for example. Various exceptional settings or exclusion processing described above is performed thereby to restrict unnecessary information from being presented, which contributes to rapidly acquiring collateral information on a truly necessary person, thereby enhancing convenience.

When determining that a surrounding person is not an interview candidate in the interview candidate determination processing in step S900, the main controller 2 proceeds to the termination instruction determination processing in step S434.

In step S434, the main controller 2 monitors an input signal from the operation input 9, for example, thereby to determine whether the user 10 or the like has instructed to terminate the processing in the present embodiment.

Here, when determining that the processing has been instructed to terminate (step S434: YES), the main controller 2 terminates the routine (the interview candidate determination and information acquisition processing) of FIG. 8 (step S436).

To the contrary, when determining that the processing has not been instructed to terminate yet (step S434: NO), the main controller 2 returns to the surrounding shooting processing (step S432) of shooting the surroundings of the HMD 1 in order to continue the routine of FIG. 8.

In this way, when determining that a surrounding person is an interview candidate (step S900: YES) in the interview candidate determination processing in step S900, the main controller 2 performs the face information detection processing (step S420) as a defined processing (subroutine).

Incidentally, the main controller 2 may give indication 1100 that the portable information terminal has recognized an interview candidate as depicted in FIG. 22A, for example, (or may display a message that “there is an interview candidate” in the depicted example) even before acquiring information on the interview candidate. At this time, the main controller 2 may display a mark 1101 indicating the person in an overlapping manner in order to notify the user of the position of the interview candidate. The mark 1101 is displayed in a graphic surrounding the person 15 as an interview candidate in the depicted example, but may be displayed in other graphic such as “arrow” pointing the person 15, for example.

Further, the face information detection processing (step S420) has been described in detail in the flowchart of FIG. 6, and the description thereof will be omitted herein.

After the end of the face information detection processing (step S420), the main controller 2 performs the interviewee information processing (step S450) as a defined processing (subroutine). The interviewee information processing (step S450) is a processing of identifying an interviewee and acquiring collateral information on the interviewee.

After the end of the interviewee information processing (step S450), the main controller 2 terminates the interviewee identification and information acquisition processing according to the present embodiment (step S436).

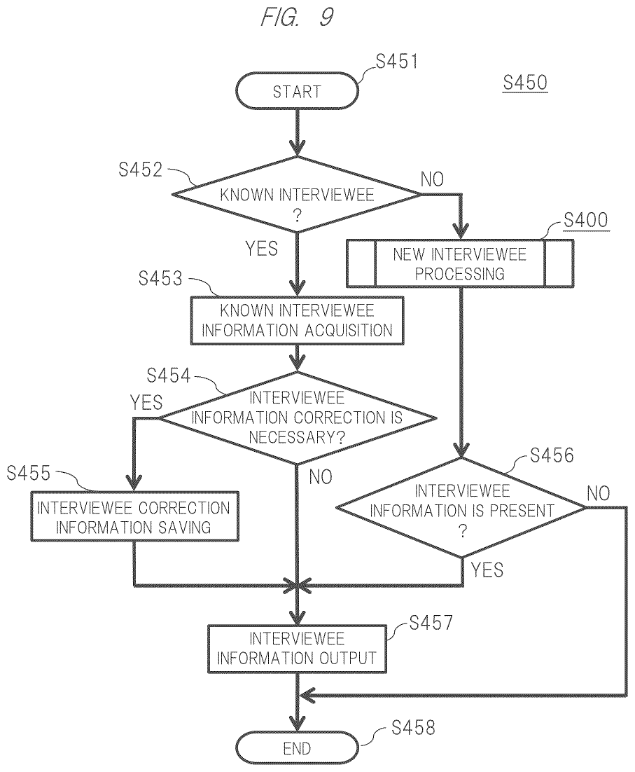

More specific contents of the interviewee information processing (processings in a subroutine of step S450) will be described herein. FIG. 9 is a flowchart depicting a processing procedure of the interviewee information processing (step S450) as a subroutine. The processing procedure of FIG. 9 will be described with reference to the hardware block diagram of FIG. 3 and the functional block diagram of FIG. 4 as needed.

When starting the processing (interviewee information processing) in step S450 (step S451), at first the main controller 2 determines whether the face information detected in the face information detection processing (step S420) is face information on a known interviewee (step S452).

In this example, the main controller 2 compares the face information (face feature) detected in the face information detection processing (step S420) with the face information (face features) saved by the face information saving function 25, and if both are remarkably similar (if a degree of coincidence in the outer shape (contour) of the face is within a preset threshold), determines that the interviewee is known. Incidentally, many people wear a mask for preventing infections in recent years, and thus the main controller 2 determines, for a person wearing a mask, whether a degree of coincidence in the outer shape (contour) of the face except the mask is within the threshold.

When NO in step S452 or when the detected face information (face feature) does not coincide with the saved face information (face feature) or enough face information to identify the person has not been detected in the face information detection processing (step S420), the main controller 2 determines that the interviewee is not known, and proceeds to step S400.

To the contrary, when YES in step S452 or when the detected face information (face feature) coincides with the saved face information (face feature), the main controller 2 proceeds to step S453. The main controller 2 acquires collateral information on the known interviewee saved by the interviewee information saving function 26 in step S453, and proceeds to step S454.

In step S454, the main controller 2 determines whether the collateral information on the known interviewee needs to be corrected.

Here, when determining that the collateral information on the known interviewee does not need to be corrected (step S454: NO), the main controller 2 proceeds to an interviewee information output processing (step S457).

To the contrary, when determining that the collateral information on the known interviewee needs to be corrected (step S454: YES), the main controller 2 proceeds to a corrected interviewee information saving processing (step S455) of saving corrected interviewee information.

In the corrected interviewee information saving processing (step S455), the main controller 2 corrects the interviewee information saved by the interviewee information saving function 26 and saves the corrected interviewee information. After the end of the corrected interviewee information saving processing (step S455), the main controller 2 proceeds to the interviewee information output processing (step S457).

To the contrary, when it is determined that the interviewee is not known (step S452: NO) in the determination processing in step S452, there is no information on the interviewee, and information on the interviewee needs to be newly acquired. Thus, the main controller 2 performs the new interviewee processing (step S400) according to the present embodiment. Incidentally, the new interviewee processing (step S400) has been described in detail in the flowchart of FIG. 5 and the description thereof will be omitted herein.

Next, the main controller 2 determines whether information on the interviewee has been acquired (step S456) in the new interviewee processing (step S400).

Here, when determining that new information on the interviewee has been acquired (step S456: YES), the main controller 2 proceeds to the interviewee information output processing (step S457). Incidentally, when the collateral information on the interviewee has been acquired in the new interviewee processing (step S400), new information on the interviewee has been saved and thus the main controller 2 can proceed to the interviewee information output processing (step S457).

In the interviewee information output processing (step S457), the main controller 2 outputs the collateral information on the interviewee to the outside by the interviewee information output function 27. In the present embodiment, the main controller 2 outputs and displays information 1102 on the interviewee on the display 72 in the video processor 7 (see FIG. 22B).

After the end of the interviewee information output processing (step S457), the main controller 2 terminates the interviewee information processing (step S450) (step S458). Further, also when determining that information on the interviewee has not been acquired in the determination processing in step S456, the main controller 2 terminates the interviewee information processing (step S450) (step S458).

The face information on the new interviewee and the collateral information on the new interviewee are previously acquired and saved in the present embodiment. The main controller 2 then determines whether a surrounding person can be an interviewee by analyzing his/her behavior before the user recognizes the person, and when determining that the person can be an interviewee, displays text information such as the name or the like of the person as collateral information on the display screen 75 to be presented to the user 10 (see FIG. 22B and others).

As other example, collateral information to be saved or presented may be graphic information such as illustrations or the like, or may be voice information to be output from the right speaker 821 or the left speaker 822.

In this way, the HMD 1 (portable information terminal) according to the first embodiment includes the surrounding information acquiring apparatus (the sensor 5, the imager 71, the voice input 81) configured to acquire surrounding information on the terminal and the user 10, the behavior analysis processing apparatus (the main controller 2, the behavior analysis processor 74) configured to determine whether an interview candidate (person who is seeing the user) is present for the user 10 by analyzing behaviors of the person included in the acquired surrounding information, and the information presenting apparatus (the display 72) configured to present collateral information on an interview candidate to the user 10 when it is determined that the interview candidate is present.

With the HMD 1, collateral information on an interviewee can be more rapidly provided to the user 10, and the user 10 knows the collateral information on the interviewee when the user 10 recognizes the person as an interviewee.

Therefore, with the HMD 1 according to the present disclosure, problems of time lag in conventional apparatuses, or problems of inconvenience such as a gap in conversation at the start of an interview if the interview is started with no or less information on an interviewee can be effectively prevented.

### Second Embodiment

A second embodiment according to the present disclosure will be described below. Incidentally, a basic hardware configuration and a basic software configuration of the second embodiment are similar as in the first embodiment, and differences between the present embodiment (the second embodiment) and the first embodiment will be mainly described below and the common points will not be repeatedly described when possible.

An interview candidate is identified by use of face information on interviewees in the first embodiment. To the contrary, an interview candidate is identified by additional use of his/her voice information in the present embodiment. The present embodiment will be described below.

### [Exemplary System Configuration of Second Embodiment]

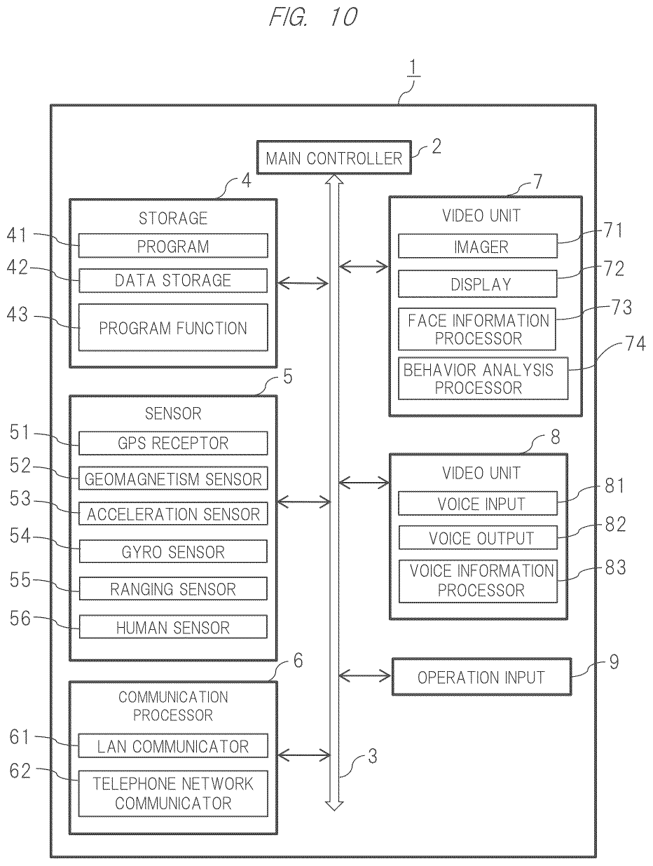

FIG. 10 is a system configuration diagram depicting an exemplary internal configuration of the HMD 1 used in the present embodiment. The system configuration diagram of FIG. 10 is almost the same as the system configuration diagram of FIG. 3, where a voice information processor 83 is added to the system configuration diagram of FIG. 3. A configuration of only the voice information processor 83 will be described herein.

The voice information processor 83 performs a function to perform a processing of extracting voice information from voice of an interviewee input from the voice input 81. As a specific example, the voice information processor 83 uses a different hardware processor from the main controller 2 thereby to perform the function under control of the main controller 2. Incidentally, the processings performed by the voice information processor 83 will be described below in detail.

### [Functional Blocks of Present Embodiment]

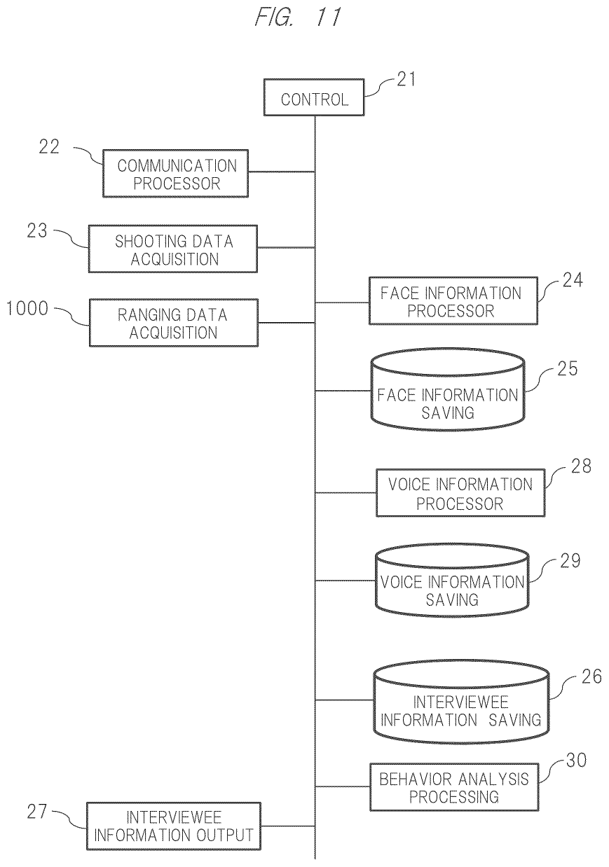

FIG. 11 is a functional block diagram depicting an exemplary functional block configuration of the HMD 1 according to the present embodiment.

The functional block diagram of FIG. 11 is almost the same as the above-described functional block diagram of FIG. 4, where a voice information processor function 28 and a voice information saving function 29 are added to the functional block diagram of FIG. 4. The voice information processor function 28 and the voice information saving function 29, which are added, will be described below.

The voice information processor function 28 is to analyze voice information by the voice information processor 83 and to determine an interviewee on the basis of voice of the interviewee input from the voice input 81, and is one of the functions performed by the voice information processor 83 described in FIG. 10.

The voice information saving function 29 is to save voice information, acquired by the voice information processor function 28, for determining an interviewee in the data storage 42 in the storage 4.

### [Processing Procedure of Second Embodiment]

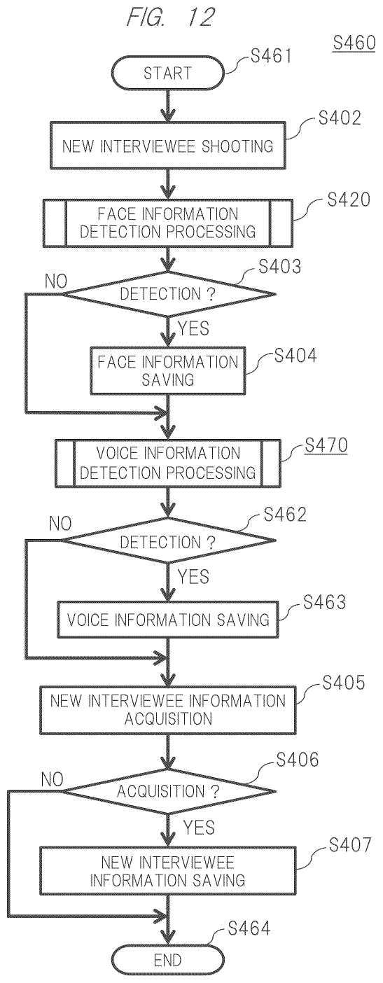

FIG. 12 is a flowchart depicting a procedure of a new interviewee processing (step S460) of acquiring information including voice information on a new interviewee according to the present embodiment. The processing procedure of FIG. 12 will be described below with reference to the functional block diagram of FIG. 11.

It is desirable that a permission to perform the new interviewee processing (step S460) is previously obtained from a new interviewee in terms of personal information protection. However, the permission does not mean technical limitation.

The flowchart depicting the procedure of the new interviewee processing (step S460) of FIG. 12 is almost the same as the flowchart depicting the procedure of the new interviewee processing (step S400) of FIG. 5. Differences lie in that a voice information detection processing (step S470) as a defined subroutine, a determination processing (step S462) of determining a detection result of the voice information detection processing (step S470), and a saving processing (step S463) of saving voice information acquired in the voice information detection processing (step S470) are added. Only the processings added to FIG. 12 will be described herein.

When the new interviewee processing (step S460) according to the present embodiment is started (step S461), the processings (step S402 to step S404) equivalent to those in FIG. 5 are performed to terminate the processings for face information.

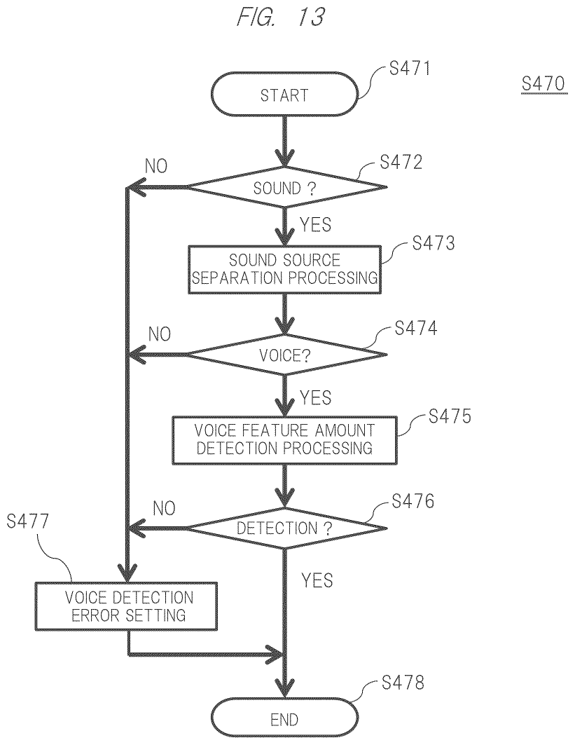

The processing (the voice information detection processing) in step S470 as a subroutine will be described herein. FIG. 13 is a flowchart depicting a processing procedure of the voice information detection processing (step S470) as a subroutine. The processing procedure of FIG. 13 will be described below with reference to the functional block diagram of FIG. 11.

In order to perform the voice information processor function 28, the voice information processor 83 reads programs of a voice recognition method stored in the program 41 in the storage 4 (step S471) and sequentially performs the processings in and subsequent to step S472 under control of the main controller 2.

When the processing (the voice information detection processing) in step S470 is started, at first the voice information processor 83 determines whether sound has been detected (step S472).

Here, when determining that sound has not been detected (step S472: YES), the voice information processor 83 proceeds to a voice detection error setting processing (step S477). To the contrary, when determining that sound has been detected (step S472: NO), the voice information processor 83 proceeds to step S473 (a sound source separation processing).

In step S473 (the sound source separation processing), the voice information processor 83 confirms a direction of the sound, and specifies (separates) the position of its sound source. In the present embodiment, the position of the mouse from which the new interviewee produces sound is assumed as the position of the sound source.

In next step S474, the voice information processor 83 determines whether the sound whose sound source has been specified (separated) is human voice. Incidentally, human voice can be determined (identified) on the basis of frequency bands of sound, features of waveforms, and the like, for example. The technique is well known and its detailed description will be omitted.

Here, when determining that the sound is not human voice (step S474: NO), the voice information processor 83 proceeds to the voice detection error setting processing (step S477). To the contrary, when determining that the sound is human voice (step S474: YES), the voice information processor 83 proceeds to a voice feature amount detection processing (step S475).

In the voice feature amount detection processing (step S475), the voice information processor 83 extracts personal elements (such as manners of speaking, conversation habits, and intonations) as voice features. Incidentally, other method capable of identifying personal features (for example, a method for identifying a specific person when a specific rare language is extracted) may be employed.

In next step S476, the voice information processor 83 determines whether a personal feature (voice feature amount in this example) has been detected from a processing result in the voice feature amount detection processing (step S475).

Here, when determining that a voice feature amount has not been detected (step S476: NO), the voice information processor 83 proceeds to the voice detection error setting processing (step S477).

To the contrary, when determining that a voice feature amount has been detected (step S476: YES), the voice information processor 83 terminates the voice information detection processing (step S470) (step S478).

In the voice detection error setting processing (step S477), the voice information processor 83 clearly displays, on the display 72, when the voice detection error occurred. Thereafter, the voice information detection processing (step S470) is terminated (step S478).

As other example of the voice information detection processing (step S470), the HMD 1 can send, via the network 33, the acquired voice of the new interviewee to the network server 32 which performs the voice information detection processing, thereby performing the voice information detection processing in the network server 32. At this time, the communication processor 6 in the HMD 1 receives only a voice information detection result from the network server 32 via the network 33 under control of the main controller 2.

Further, the main controller 2 in the HMD 1 can cause different network servers 32 to perform the face information detection processing and the voice information detection processing, respectively, via the communication processor 6.

Returning to the processing procedure of FIG. 12, the processings performed by the main controller 2 or the voice information processor 83 will be subsequently described herein. The main controller 2 (or the voice information processor, which performs the processings until S464 below) determines whether voice information on the new interviewee has been acquired (step S462) in the voice information detection processing (step S470) after the voice information detection processing (step S470).

When determining that voice information on the new interviewee has not been acquired in the voice information detection processing (step S470) in the determination processing in step S462, the main controller 2 proceeds to the new interviewee information acquisition processing (step S405) since there is no voice information to be saved.

When determining that voice information on the new interviewee has been acquired in the voice information detection processing (step S470) in the determination processing in step S462, the main controller 2 proceeds to the voice information saving processing (step S463).

In the voice information saving processing (step S463), the main controller 2 saves voice feature amounts of the interviewee for interviewee's voice identification in the data storage 42 in the storage 4 by the voice information saving function 29. The main controller 2 then proceeds to the new interviewee information acquisition processing (step S405).

In the processings subsequent to the new interviewee information acquisition processing (step S405), the main controller 2 performs the processings (steps S406 and S407) equivalent to those in the flowchart of FIG. 5 and terminates the new interviewee processing (step S460) according to the present embodiment (step S464).

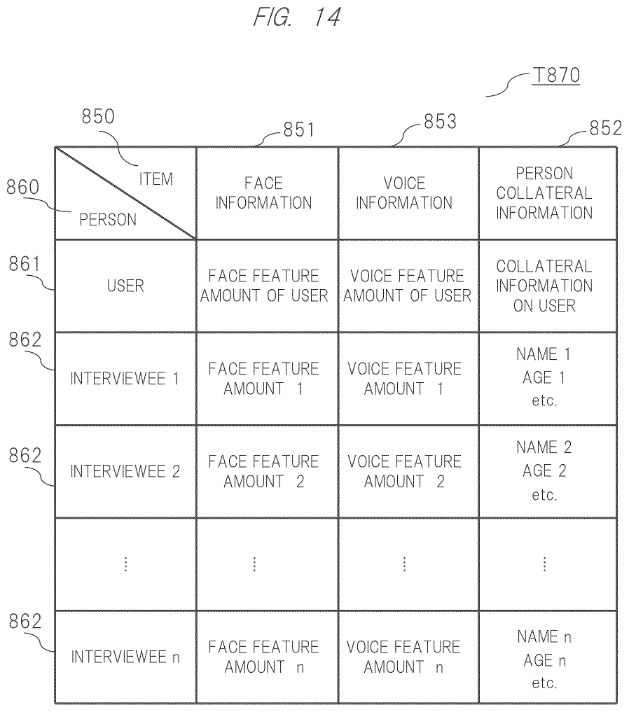

FIG. 14 is a table (T870) depicting exemplary interviewee information saved in the present embodiment. The interviewee table (T870) of FIG. 14 is configured of interviewee (person) types 860 and information items 850 for interviewees.

The information items 850 for interviewees are configured of three items including face information 851, voice information 853, and collateral information 852 on interviewee. The interviewee (person) types 860 include the user 861 in addition to the interviewees (862 to 864).

The user 861 is included in the interviewee types in order to present a profile in a cell phone and to separate the voice information on the user from voice of new interviewees during conversations with the new interviewees.

The interviewee table (T870) can be sent from the HMD 1 to the network server 32 via the network 33 (see FIG. 1) to be saved in a storage medium in the network server 32. In particular, the network server 32 dedicated to the processings of specifying an interviewee from face feature amounts or voice feature amounts is used for face feature amounts or voice information, thereby achieving the processings of specifying an interviewee in the HMD 1 at higher speed.

As described above, information on a new interviewee added with voice information can be acquired and saved in the processings of FIGS. 12 and 13 and by the table of FIG. 14 in the present embodiment.

### <Interviewee Identification and Information Acquisition Processing>

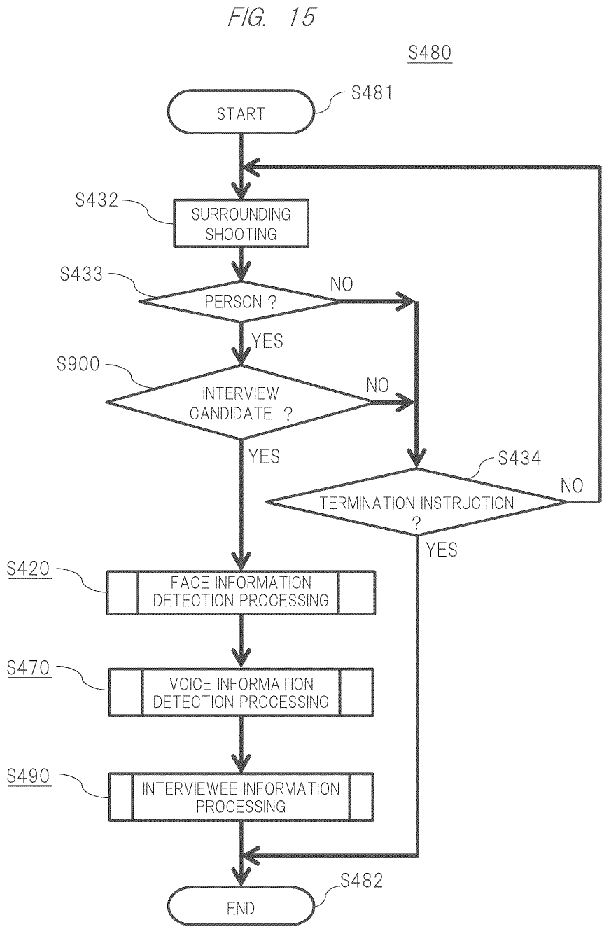

A processing of identifying an interviewee and acquiring collateral information on the interviewee will be described below. FIG. 15 is a flowchart depicting, as a framework of the present embodiment, a procedure of the processing (interviewee identification and information acquisition processing) of determining whether a person can be an interviewee in consideration of voice information, and when the person can be an interviewee, previously acquiring collateral information on the interviewee. The processing procedure of FIG. 15 will be described with reference to the functional block diagram of FIG. 11.

The flowchart of the second embodiment in FIG. 15 is almost the same as the flowchart of the first embodiment in FIG. 8, and is different therefrom in processing contents of an interviewee information processing. Thus, the interviewee information processing according to the second embodiment is denoted with a different step number (step S490) than in the first embodiment (step S450) for discrimination.

Further, the second embodiment is different from the first embodiment in that the voice information detection processing (step S470) as a defined subroutine is added. Incidentally, the voice information detection processing (step S470) has been described in detail in the flowchart of FIG. 13 and will not be repeatedly described.

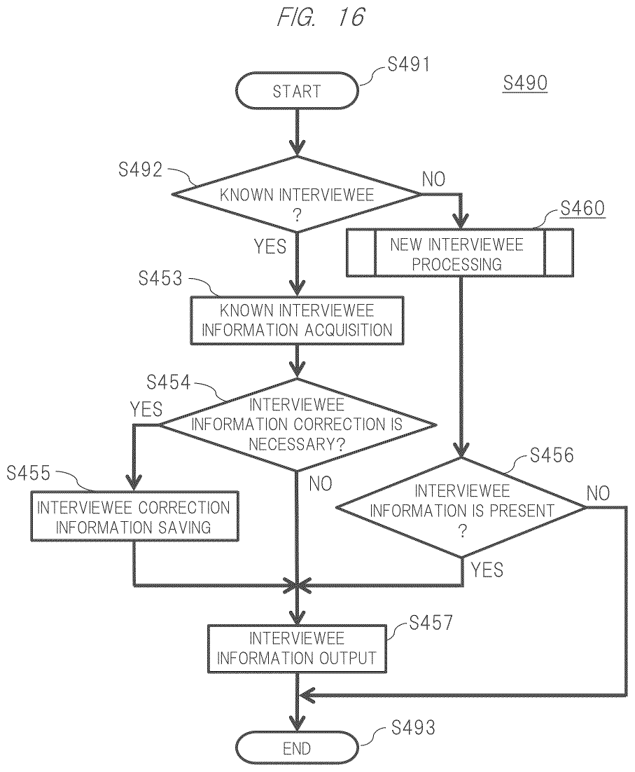

FIG. 16 is a flowchart (subroutine) depicting the processing procedure of the interviewee information processing (step S490) according to the second embodiment in detail. The processing procedure of FIG. 16 will be described in detail with reference to the hardware block diagram of FIG. 10 and the functional block diagram of FIG. 11.

The flowchart of the second embodiment in FIG. 16 is almost the same as the flowchart of the first embodiment in FIG. 9 and is different therefrom in contents of a processing of determining whether an interviewee is known. Thus, the determination processing in the second embodiment is denoted with a different step number (step S492) than in the first embodiment (step S452) for discrimination.

Further, the second embodiment is different from the first embodiment in a new interviewee processing, and the new interviewee processing is denoted with a different step number (step S460) from the step number (step S400) in the first embodiment for discrimination.

When the processing (the interviewee information processing) in step S490 is started (step S491), at first a determination is made as to whether the interviewee is known (step S492) on the basis of the face information detected in the face information detection processing (step S420).

More specifically, the face information processor 73 compares the face information (face feature) detected in the face information detection processing (step S420 in FIG. 6) with the face information (face feature) saved by the face information saving function 25, and when both coincide within a preset threshold, determines that the interviewee is known (step S492: YES).

In other example, when having acquired voice, the main controller 2 compares the voice information (voice feature amount) detected in the voice information detection processing (step 470) with the voice information (voice feature amount) saved by the voice information saving function 29, and when both coincide within a preset threshold, determines that the interviewee is known (step S492: YES).

Here, the interviewee can be determined as being known when only the face information or the voice information coincides, and the interviewee can be determined as being known when both the face information and the voice information coincide. When neither the face information nor the voice information coincides or when enough face information or voice information to specify the person has not been detected, the main controller 2 determines that the interviewee is not known (step S492: NO), and proceeds to step S460.

Incidentally, step S460 (the new interviewee processing) has been described in detail with reference to the flowchart of FIG. 12 and will not be described herein.

Thus, when the interviewee is determined as being known (step S492: YES), the processings in steps S453 to S457 in FIG. 9 are performed and the interviewee information processing (step S490) according to the present embodiment is terminated (step S493).

As described above, the configuration of the present embodiment enables an interview candidate to be identified in consideration of voice information, thereby enhancing accuracy in providing information on an interviewee.

### Third Embodiment

A third embodiment according to the present invention will be described below. Incidentally, a basic hardware configuration and a basic software configuration of the third embodiment are similar as in the above embodiments, and differences between the present embodiment (the third embodiment) and the above embodiments will be mainly described below and the common points will not be repeatedly described when possible.

The above embodiments assume that the user wears a glasses-type HMD and an interviewee needs to be present in front of the user in order to be recognized. The present embodiment assumes that a user wears a glasses-type HMD, and will discuss a case in which an interviewee (candidate) is difficult to easily recognize for the user when the interviewee is present behind the user. The present embodiment will be described below.

### [Outlines of Operations and Others]

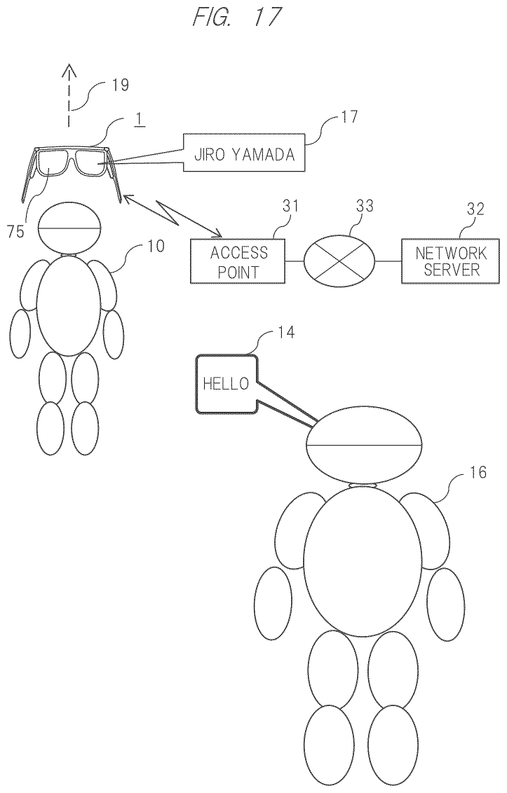

FIG. 17 is a schematic diagram for explaining a background of the present embodiment. For clear comparison with FIG. 1, FIG. 17 depicts a state in which an interviewee is present neither in the line of sight 19 (see a dotted line in FIG. 17) of the user 10 wearing the glasses-type HMD 1 nor in view of the user 10. Furter, FIG. 17 depicts a state in which an interviewee 16 is approaching from behind the user 10 and the interviewee 16 earlier recognizes the presence of the user 10 and produces voice 14 of “Hello” in a balloon than the user 10 recognizes the presence of the interviewee 16.

In the present embodiment, the HMD 1 is configured such that the HMD 1 is activated in response to the voice 14 of “Hello” in a scene as depicted in FIG. 17 to perform a processing of analyzing a video and voice around the HMD 1 rapidly after the activation, thereby recognizing the person 16.

Here, the HMD 1 determines whether the person 16 can be an interviewee (or an interview candidate) as a processing of analyzing surrounding video and voice, and when the person 16 can be an interviewee, acquires collateral information on the person 16 and displays the acquired collateral information on the display screen 75. In the example of FIG. 17, the HMD 1 displays a name (Jiro Yamada) 17 as the collateral information on the person 16 on the display screen 75.

Further, the HMD 1 is connected to the network 33 connected with the network server 32 via the access point 31 as depicted in FIG. 17. Here, the network server 32 includes a network server for performing various computation processings, a network server for saving various items of data, and the like, and can be utilized by the HMD 1 as needed.

As a specific example, the main controller 2 can control and cause an external server (the network server 32) to perform the processings of the behavior analysis processor 74 (the behavior analysis processing apparatus) in the HMD 1 via the communication processor 6 (the communication apparatus).

With the configuration, the resources in the entire HMD 1 can be efficiently used, and thus the processing speed is enhanced thereby to rapidly present necessary information to the user.

### [Processing of Acquiring Collateral Information]

A processing of identifying an interviewee and acquiring collateral information on the interviewee will be described below.

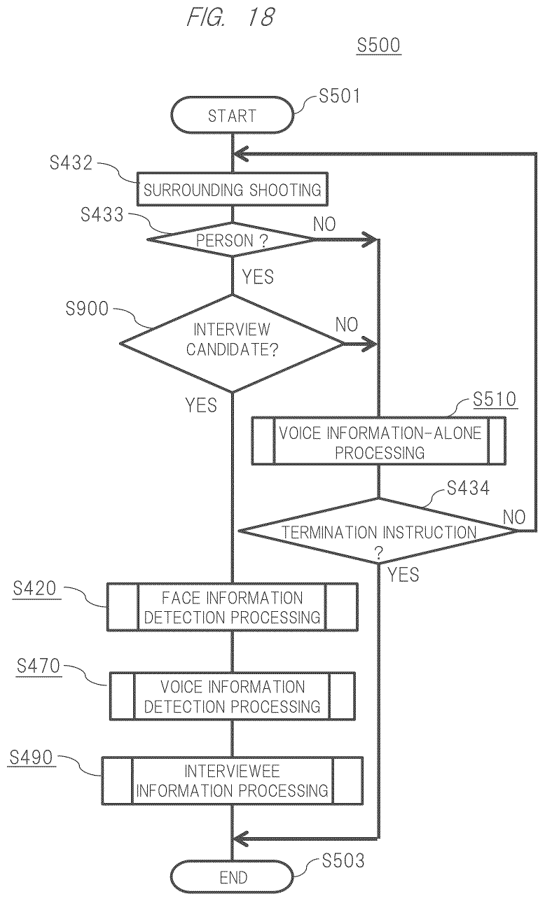

FIG. 18 is a flowchart depicting, as a framework of the present embodiment, a procedure of a processing (interviewee identification and information acquisition processing) step S500 of determining whether a person can be an interviewee on the basis of voice information, and when the person can be an interviewee, previously acquiring collateral information on the interviewee. The processing procedure of FIG. 18 will be described with reference to the functional block diagram of FIG. 11.

The flowchart depicting the processing procedure in FIG. 18 is almost the same as the flowchart depicting the procedure in FIG. 15, where a voice information-alone processing (step S510) as a defined subroutine is added.

When the interviewee identification and information acquisition processing (step S500) is started (step S501), the same processings as in the flowchart of FIG. 15 are performed, but when determining that a person is not present around (step S433: NO) from image information and when determining that an interview candidate is not present around (step S900: NO) from image information, the HMD 1 performs the voice information-alone processing (step S510) as a subroutine.

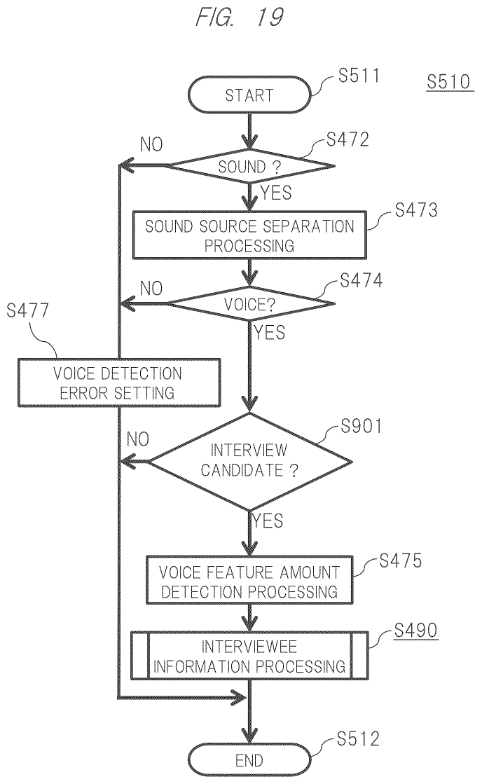

The processing (the voice information-alone processing) in step S510 as a subroutine will be described herein. FIG. 19 is a flowchart depicting a processing procedure of the voice information-alone processing (step S510) as a subroutine. The processing procedure of FIG. 19 will be described with reference to the functional block diagram of FIG. 11.

The voice-alone processing (step S510) according to the third embodiment in FIG. 19 is almost the same as the voice information detection processing (step S470) in FIG. 13 (the second embodiment). Differences from FIG. 13 lie in that the third embodiment does not include the determination processing in step S476 and is added with interview candidate determination (step S901) and the interview information processing (step S490) as a subroutine.

After starting the voice-alone processing (step S510) (step S511), the HMD 1 performs the same processings as the processings depicted in FIG. 13 from step S472 to step S474. Further, the voice detection error setting processing in step S477 is also as stated above.

In step S901 subsequent to step S474, the HMD 1 determines whether the voice is of an interview candidate. As a specific example, in step S901, the HMD 1 determines whether contents of the voice can be a call for the user.

Here, contents of voice can be a call for the user in the following cases, for example:
(1) including the name of the user,
(2) being a call for someone (such as “excuse me” or “would you be Mr,” for example)

Thus, in the case of (1) or (2), the HMD 1 determines that the voice is of an interview candidate (step S901: YES). In this case, the HMD 1 proceeds to the voice feature amount detection processing (step S475) in FIG. 13.

To the contrary, when it is determined that the voice is not of an interview candidate (step S901: NO) in the interview candidate determination in step S901, the processing proceeds to the termination processing in the routine.

After the voice feature detection processing (step S475), the HMD 1 performs the interviewee information processing (step S490) in the subroutine of FIG. 16 and then terminates the voice-alone processing (step S510) (step S512).

The HMD 1 according to the third embodiment, which performs the voice-alone processing (step S510), can determine an interview candidate from only voice information and can acquire collateral information on the interview candidate even if the interview candidate cannot be determined from image information. Thus, even when an image of a person cannot be completely acquired in the crowds, for example, or when the imager 71 breaks down, information on an interview candidate can be acquired.

### Fourth Embodiment

A fourth embodiment according to the present invention will be described below. Incidentally, a basic hardware configuration and a basic software configuration of the fourth embodiment are similar as in the first to third embodiments, and differences between the present embodiment (the fourth embodiment) and the first to third embodiments will be mainly described below and the common points will not be repeatedly described when possible.

The first to third embodiments assume that a glasses-type HMD is worn. To the contrary, the fourth embodiment will discuss a case in which an HMD in any type other than glasses-type is worn. The present embodiment will be described below.

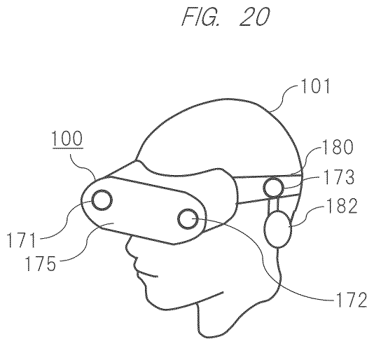

FIG. 20 is an appearance view depicting an exemplary HMD used in the fourth embodiment. An HMD 100 depicted in FIG. 20 has goggles-type casing (simply referred to as “goggles” below) and outer shape, and includes an HMD mounting belt 180. As depicted in FIG. 20, a user 101 wears the HMD mounting belt 180 on the back of the head thereby to mount the HMD 100 on the head of the user 101.

In the HMD 100, a display screen (display on which an image is displayed) 175 is arranged on the front of the goggles, and a left camera 172 and a right camera 171 are arranged on the left and the right of the front of the goggles, respectively.

Further, the right and left speakers are arranged at the positions corresponding to the ears of the user 101 in the HMD 100. Incidentally, a left speaker 182 is depicted in FIG. 20, and a right speaker is in the shadow of the user 101 and is not depicted.

In the example of FIG. 20, a left-side camera 173 different from the left camera 172 is arranged near the left speaker 182. Further, though not depicted, a rear camera different from the cameras (171, 172, and 173) is arranged at the position corresponding to the back of the head of the user 101 in the HMD mounting belt 180. Furthermore, though not depicted, a right-side camera different from the right camera 171 is also arranged near the right speaker.

In this way, more cameras are added or installed thereby to enlarge the shooting range around the user 101 in the present embodiment. In particular, the rear camera is arranged on the back of the user 101, and face information on the person 16 behind the user 101 can be recognized without the user's 101 looking back even in the positional relationship of FIG. 17.

The fourth embodiment is characterized in that more cameras are installed thereby to enlarge the shooting range around the user 101. In other words, in the fourth embodiment, the surrounding information acquiring apparatus includes a plurality of cameras configured to acquire videos and each camera is arranged to acquire videos in a wider range than the view of the user 101.

In this way, with the configuration in which apparatuses in the surrounding information acquiring apparatus are arranged to acquire surrounding information out of view of the user 101, an interview candidate, who is not recognized by the user 101, is more likely to be captured and convenience also enhances.

Further, the example in which cameras are used as apparatuses in the surrounding information acquiring apparatus has been described here, but in other example, a plurality of ranging sensors 55 or a plurality of human sensors 56 (see FIG. 3) may be arranged, for example.

### Fifth Embodiment

A fifth embodiment according to the present invention will be described below. Incidentally, a basic hardware configuration and a basic software configuration of the fifth embodiment are similar as in the above embodiments, and differences between the present embodiment (the fifth embodiment) and the above embodiments will be mainly described below and the common points will not be repeatedly described when possible. The first to fourth embodiments assume one interview candidate. To the contrary, the fifth embodiment assumes a plurality of interview candidates. The present embodiment will be described below.

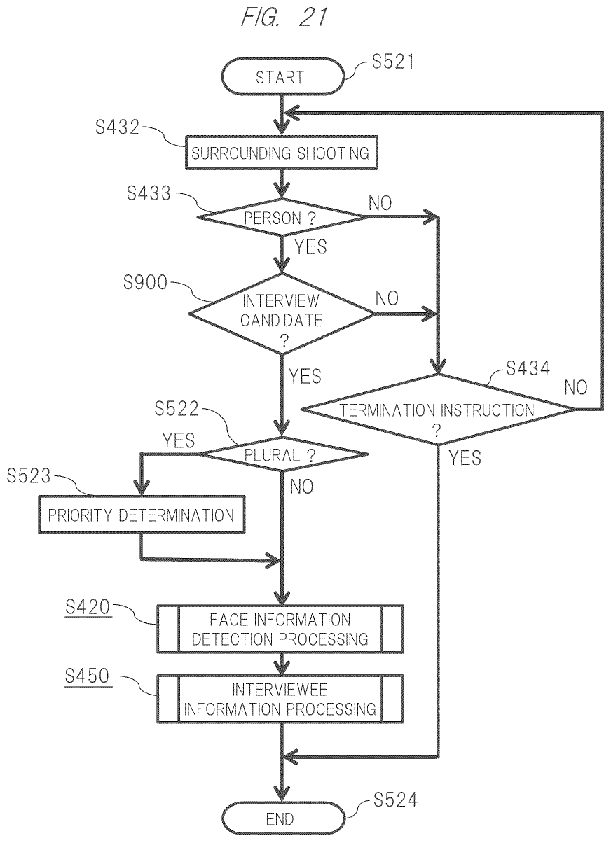

FIG. 21 is a flowchart depicting, as a framework of the present embodiment, a procedure of a processing (interviewee identification and information acquisition processing) of determining whether a person can be an interviewee, and when the person can be an interviewee, previously acquiring collateral information on the interviewee.

The interviewee identification and information acquisition processing in FIG. 21 is almost the same as the interviewee identification and information acquisition processing in FIG. 8 and is different therefrom in that a processing of determining whether a plurality of persons can be interviewees (step S522) and a priority determination processing (step S523) are added.

When the interviewee identification and information acquisition processing according to the present embodiment is started (step S521), the HMD 1 performs step S432 (the surrounding shooting processing), step S433 (the processing of determining whether a person is present), and step S900 (the processing of determining whether the person is an interview candidate) described in FIG. 8.

When determining that the person is an interview candidate (step S900: YES), the HMD 1 then proceeds to step S522. In step S522, the HMD 1 determines whether the number of persons detected as interview candidates is one or plural.

In step S522, when one person has been detected (step S522: NO), the HMD 1 performs the face information detection processing (step S420) and the interviewee information processing (step S450) and then terminates the routine as in the other embodiments.

To the contrary, in step S522, when a plurality of interview candidates (also simply referred to as “interview candidates” below) have been detected, the HMD 1 proceeds to the priority determination processing (step S523).

The significance of the priority determination processing will be described herein. When there is room for processing speeds of the processors or resources of the RAM and the like in the HMD 1, all of interview candidates may be addressed.

However, hardware resources are not actually enough in many cases, and particularly when the original functions of the HMD 1 are being performed (a moving image of predetermined contents is being reproduced, for example), processing time to acquire information on all interview candidates is longer. Such prolonged processing time can cause the above problems (such as increase in psychological load on the user who cannot remember the name of the face-to-face person or the like) if at least one of the face-to-face persons sees the user and an interview (conversation or the like) starts therebetween.

The present inventors have thought that if there are a plurality of interview candidates, it is effective to limit or order persons whose information is to be acquired in consideration of the above problems, and provides the priority determination configuration.

Specifically, in the priority determination processing (step S523), the HMD 1 specifies, as a priority person, a person who is most likely to be an interviewee or may be the most important among a plurality of possible interviewees.

More specifically, in step S523, the HMD 1 performs predetermined weighting on each of the following behaviors and determines its priority, and specifies a person with the highest priority as a priority person:
(A) A line of sight of a person is toward the user.
(B) A person is greeting the user by raising a hand, for example.
(C) A person is approaching the user.
(D) A distance between a person and the user is short.

When the priority determination processing (step S523) is performed, possible candidates are limited to one person, which is similar as in the other embodiments. Thus, thereafter, the HMD1 sequentially performs the face information detection processing (step S420) and the interviewee information processing (step S450) and then terminates the routine as in the other embodiments.

As exemplary weighting setting, in step S523, the HMD 1 specifies (D) among the above (A) to (D), or a person closest to the user as a priority person. With the processing, a person who is most likely to start an interview (conversation) among a plurality of interview candidates is specified as a priority person, and the user can rapidly know information on the person (see also step S450).

As other exemplary weighting setting, in step S523, the HMD 1 specifies (B) among the above (A) to (D), or a person who is greeting the user by raising a hand, or the like as a priority person. This assumes that when there are a plurality of interviewees including a superior and a subordinate, the superior (higher-status person) may generally greet, the superior is not necessarily in front of the subordinate, and the subordinate may guide the superior ahead.

The weighting may be arbitrarily set in advance by the user's operating the operation input 9, or the like.

Further, the example of FIG. 21 is configured such that information on only one person is acquired. In other example, when there are a plurality of interview candidates, the processings in step S420 and step S450 may be sequentially performed in descending order of priority specified in the priority determination processing (step S523). With the processings, the information on all the interview candidates can be presented to the user in descending order of priority (or importance) while the hardware resources of the HMD 1 are being effectively used.

In still other example, when there are a plurality of interview candidates, the processings in step S420 and step S450 may be performed in descending order of priority specified in the priority determination processing (step S523) for preset N (N is an integer of 1 or more) persons. Such processings are effective for a large number of interview candidates, for example, and information on a certain number of interview candidates can be presented to the user in descending order of priority (or importance) while the hardware resources of the HMD 1 are being effectively used.

Further, as a variant of the priority ordering processing, as depicted in FIGS. 22A, 22B, and 23, simple information on an interview candidate who is far away may be displayed (FIG. 22A) and detailed information on an interview candidate who is approaching the user may be displayed (FIG. 22B).

With reference to FIG. 23, on the HMD 1, simple information 1103a and 1103c (only the name in this example) are displayed for persons 15a and 15c who are far away, respectively, and detailed information 1104b (the name and other information in this example) is displayed for a person 15b who is near.

In this way, levels of detail of information to be displayed (or presented or notified to the user) are changed depending on a distance to an interview candidate (target person), and thus the user can concentrate on information on a person whose information the user wants more, and convenience is enhanced.

When the processings in the variant are performed, the processings similar as in the other embodiments are performed on all the interview candidates (target persons), and then the interviewee identification and information acquisition processing according to the present embodiment may be terminated (step S524).

As described above, with the configuration of the fifth embodiment, a plurality of possible interview candidates can be rapidly addressed.

As described above in detail, the portable information terminal (the HMD 1, 100) according to the present disclosure includes the surrounding information acquiring apparatus (the sensor 5, the imager 71, the voice input 81) configured to acquire surrounding information of the terminal and the user 10, the behavior analysis processing apparatus (the main controller 2, the behavior analysis processor 74) configured to determine whether there is an interview candidate (who is to see the user) for the user 10 by analyzing a behavior of a person included in the acquired surrounding information, and the information presenting apparatus (the display 72) configured to present collateral information on an interview candidate to the user 10 when it is determined that the interview candidate is present.

With the portable information terminal (the HMD 1, 100) in the above configuration, collateral information on an interviewee can be rapidly provided to the user 10, and the user 10 can know the collateral information on the interviewee when the user 10 recognizes the person as an interviewee.

Further, the portable information terminal (the HMD 1, 100) is configured to acquire, as surrounding information, at least one of a video shot by the imager 71, distance information on a distance to an object including a person measured by the ranging sensor 55, and voice collected by the voice input 81.

With the configuration, the surrounding information acquiring apparatus can acquire surrounding information in consideration of advantages of various items of information, or resources (execution statuses and the like of the original functions) of the HMD 1 (100), and can rapidly provide the user 10 with collateral information on an interviewee.

Further, the portable information terminal (the HMD 1, 100) does not determine an interview candidate by the behavior analysis processor 74 depending on where surrounding information is acquired.

The configuration contributes to restricting unnecessary information from being presented and to rapidly acquiring collateral information on a truly necessary person, thereby enhancing convenience.

Further, in the portable information terminal (the HMD 1, 100), when a plurality of persons are determined as interview candidates, the behavior analysis processor 74 gives a priority to each of the interview candidates depending on behavior analysis results, and determines the number or order of interview candidates for collateral information presented by the information presenting apparatus (the display 72) depending on the given priorities.

Further, in the portable information terminal (the HMD 1, 100), when the behavior analysis processing apparatus determines that an interview candidate is present, the information presenting apparatus (the display 72) presents information indicating that an interview candidate is present, and then presents the collateral information on the interview candidate in a stepwise manner.

With the configuration, the user can further concentrate on information on a person whose information he/she wants more, thereby enhancing convenience.

Exemplary embodiments of the present invention have been described above by use of the first to fifth embodiments, but configurations achieving the technique according to the present invention are not limited to the above embodiments, and many variants may be employed. For example, some components of an embodiment may be replaced with components of other embodiment, or components of an embodiment may be added with components of other embodiment. All of these fall within the scope of the present invention. Further, numerical values, messages, and the like in the specification and the drawings are merely exemplary, and the use of different ones does not impair the effects of the present invention.

Some or all of the functions and the like of the present invention described above may be achieved in hardware by being designed in integrated circuitry, for example, and may be achieved in software by microprocessor units' and the like interpreting and executing programs for their functions and the like. Hardware and software may be used together therefor. The software may be previously stored in the program 41 or the like in the HMD 1 at the time of product shipment, or may be acquired from various server apparatuses or the like on Internet after the product shipment. Furthermore, the software provided in a memory card, an optical disk, or the like may be acquired.

Moreover, control lines and information lines, which may be required for description, are depicted in the drawings, and not all of the control lines and information lines for the product are necessarily depicted. Almost all the components are mutually connected in practice.

### EXPLANATION OF SYMBOLS

1 . . . HMD (Portable information terminal); 2 . . . Main controller; 3 . . . System bus; 4 . . . Storage; 5 . . . Sensor; 6 . . . Communication processor (communicator); 7 . . . Video processor; 8 . . . Voice processor; 9 . . . Operation input; 10 . . . User; 15 . . . Person (interview candidate); 16 . . . Person (interviewee); 32 . . . Network server; 42 . . . Data storage; 71 . . . Imager (surrounding information acquiring apparatus); 72 . . . Display (information presenting apparatus); 73 . . . Face information processor; 74 . . . Behavior analysis processor (behavior analysis processor); 75 . . . Display screen; 81 . . . Voice input (surrounding information acquiring apparatus); 82 . . . Voice output; 83 . . . Voice information processor); 100 . . . HMD (portable information terminal); 171 . . . Right camera; 172 . . . Left camera; 173 . . . Left-side camera; 175 . . . Display screen; 711 . . . Right camera; and 712 . . . Left camera.

1. A portable information terminal carried by a user, the portable information terminal comprising:
a surrounding information acquiring apparatus configured to acquire surrounding information;
a behavior analysis processing apparatus configured to analyze a behavior of a person included in the acquired surrounding information and to determine an interview candidate who is to have an interview with the user; and
an information presenting apparatus configured to present collateral information on the interview candidate to the user.

2. The portable information terminal according to claim 1,
wherein the surrounding information is any one or more of a shot video, distance information on a distance measured to an object including the person, and collected voice.

3. The portable information terminal according to claim 1,
wherein when a behavior of a person included in the surrounding information is a behavior indicating interest in the user, the behavior analysis processing apparatus determines that the person is the interview candidate.

4. The portable information terminal according to claim 3,
wherein the behavior indicating the interest in the user is one or more of a behavior of shooting a glance, a greeting behavior, an approaching behavior, and a calling behavior.

5. The portable information terminal according to claim 1,
wherein the behavior analysis processing apparatus is further configured not to make a determination about the interview candidate depending on a kind of a person included in the surrounding information.

6. The portable information terminal according to claim 5,
wherein a kind of a person about which the determination is not made includes one or more of a person in charge in a service and a security guard.

7. The portable information terminal according to claim 1,
wherein the behavior analysis processing apparatus is further configured not to make a determination about the interview candidate depending on a location where the surrounding information is acquired.

8. The portable information terminal according to claim 1,
wherein when plural persons are determined as interview candidates, the behavior analysis processing apparatus:
gives a priority to each of the interview candidates according to an analysis result of the behavior; and
determines a number or order of the interview candidates relative to the collateral information presented by the information presenting apparatus in the given priority.

9. The portable information terminal according to claim 1,
wherein when the behavior analysis processing apparatus determines that the interview candidate is present, the information presenting apparatus presents information indicating that an interview candidate is present and then presents the collateral information on the interview candidate in a stepwise manner.

10. The portable information terminal according to claim 1,
wherein when plural persons are determined as interview candidates by the behavior analysis processing apparatus, the information presenting apparatus presents, to the user, the collateral information responding to the interview candidates with more detailed information presented as a distance from the user is closer.

11. The portable information terminal according to claim 1,
wherein the surrounding information acquiring apparatus includes a plurality of cameras configured to acquire a video, and
the cameras are arranged so as to acquire the video in a wider range than view of the user.

12. The portable information terminal according to claim 1,
wherein the portable information terminal is configured so that some of processings performed by the behavior analysis processing apparatus via a communicator are performed by an external server.

13. The portable information terminal according to claim 1,
wherein the portable information terminal is a head mounted display (HMD).

14. An information processing method in a portable information terminal, the method comprising:
acquiring surrounding information of a user;
analyzing a behavior of a person included in the acquired surrounding information to determine an interview candidate who is to have an interview with the user; and
presenting, to the user, collateral information responding to the determined interview candidate.
